(19) United States
(12) Patent Application Publication
(10) Pub. No.: US 2022/0039056 A1
(43) Pub. Date: Feb. 3, 2022

(54) METHODS AND APPARATUS FOR USER EQUIPMENT BASED PRIORITIZATION AND REPORTING OF POSITIONING TECHNOLOGIES AND METHODS

(71) Applicant: QUALCOMM Incorporated, San Diego, CA (US)

(72) Inventors: Alexandros MANOLAKOS, Escondido, CA (US); Mukesh KUMAR, Hyderabad (IN); Avinash SHRIVASTAVA, Hyderabad (IN); Srinivas YERRAMALLI, Hyderabad (IN)

(21) Appl. No.: 17/348,605

(22) Filed: Jun. 15, 2021

Related U.S. Application Data
(60) Provisional application No. 63/055,168, filed on Jul. 22, 2020.

(51) Int. Cl. H04W 64/00; H04W 8/24; H04W 4/38; H04W 8/12; H04W 24/10

(52) U.S. Cl. CPC H04W 64/006; H04W 8/24; H04W 84/12; H04W 8/12; H04W 24/10; H04W 4/38

(57) ABSTRACT

A user equipment (UE) provides to a location server a recommendation or request for positioning technologies and methods that may be appropriate for the environment in which the UE is located. The UE may provide the recommendation or request may be a priority list of one or more specific positioning technologies, one or more specific methods of a positioning technology, a combination thereof. The UE based prioritization for positioning may be provided unsolicited or requested by the location server. The UE based prioritization for positioning may be provided as part of a message used in current positioning protocols, such as Long Term Evolution (LTE) Positioning Protocol (LPP), e.g., by ranking information elements (IEs) associated with each positioning technology and method in the body of the message or as part of a common IE.

### CLAIM OF PRIORITY UNDER 35 U.S.C. § 119

This application claims under 35 USC § 119 the benefit of and priority to U.S. Provisional Application No. 63/055,168, filed Jul. 22, 2020, and entitled “METHODS AND APPARATUS FOR USER EQUIPMENT BASED PRIORITIZATION AND REPORTING OF POSITIONING TECHNOLOGIES AND METHODS,” which is assigned to the assignee hereof and is incorporated herein by reference in its entirety.

### BACKGROUND OF THE DISCLOSURE

### Field of the Disclosure

Aspects of the disclosure relate generally to positioning for user equipment (UE).

### Description of the Related Art

Wireless communication systems have developed through various generations, including a first-generation analog wireless phone service (1G), a second-generation (2G) digital wireless phone service (including interim 2.5G networks), a third-generation (3G) high speed data, Internet-capable wireless service, and a fourth-generation (4G) service (e.g., Long-Term Evolution (LTE), WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G/LTE standard. Furthermore, signaling efficiencies should be enhanced and latency should be substantially reduced compared to current standards.

Obtaining the locations of mobile devices that are accessing a wireless network may be useful for many applications including, for example, emergency calls, personal navigation, asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

### SUMMARY

A user equipment (UE) provides to a location server a recommendation or request for positioning technologies and methods that may be appropriate for the environment in which the UE is located. The UE may provide the recommendation or request may be a priority list of one or more specific positioning technologies, one or more specific methods of a positioning technology, a combination thereof. The UE based prioritization for positioning may be provided unsolicited or requested by the location server. The UE based prioritization for positioning may be provided as part of a message used in current positioning protocols, such as Long Term Evolution (LTE) Positioning Protocol (LPP), e.g., by ranking information elements (IEs) associated with each positioning technology and method in the body of the message or as part of a common IE.

In one implementation, a method for supporting position determination of a user equipment (UE) performed by the UE in a wireless network, includes transmitting and receiving one or more messages to and from a location server for engaging in a positioning session; and sending a message to the location server including a priority list of one or more positioning technologies, positioning methods or combination thereof for the positioning session.

In one implementation, a user equipment (UE) configured to support position determination of the UE in a wireless network, includes a wireless transceiver; at least one memory; at least one processor coupled to the wireless transceiver and the at least one memory, wherein the at least one processor is configured to: transmit and receive, via the wireless transceiver, one or more messages to and from a location server for engaging in a positioning session; and send, via the wireless transceiver, a message to the location server including a priority list of one or more positioning technologies, positioning methods or combination thereof for the positioning session.

In one implementation, a user equipment (UE) in a wireless network configured to support position determination of the UE, includes means for transmitting and receiving one or more messages to and from a location server for engaging in a positioning session; and means for sending a message to the location server including a priority list of one or more positioning technologies, positioning methods or combination thereof for the positioning session.

In one implementation, a non-transitory storage medium including program code stored thereon, the program code is operable to configure at least one processor in a user equipment (UE) in a wireless network to support position determination of the UE, the program code comprising instruction to: transmit and receive one or more messages to and from a location server for engaging in a positioning session; and send a message to the location server including a priority list of one or more positioning technologies, positioning methods or combination thereof for the positioning session.

In one implementation, a method for supporting position determination of a user equipment (UE) performed by the location server in a wireless network, includes transmit and receive one or more messages to and from the UE for engaging in a positioning session; and receiving a message from the UE including a priority list of one or more positioning technologies, positioning methods or combination thereof for the positioning session.

In one implementation, a location server configured to support position determination of a user equipment (UE) performed in a wireless network, includes an external interface; at least one memory; at least one processor coupled to the external interface and the at least one memory, wherein the at least one processor is configured to: transmit and receive, via the external interface, one or more messages to and from the UE for engaging in a positioning session; and receive, via the external interface, a message from the UE including a priority list of one or more positioning technologies, positioning methods or combination thereof for the positioning session.

In one implementation, a location server configured to support position determination of a user equipment (UE), includes means for transmitting and receiving one or more messages to and from the UE for engaging in a positioning session; and means for receiving a message from the UE including a priority list of one or more positioning technologies, positioning methods or combination thereof for the positioning session.

In one implementation, a non-transitory storage medium including program code stored thereon, the program code is operable to configure at least one processor in a location server to support position determination of a user equipment (UE), the program code comprising instructions to: transmit and receive one or more messages to and from the UE for engaging in a positioning session; and receive a message from the UE including a priority list of one or more positioning technologies, positioning methods or combination thereof for the positioning session.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a simplified diagram of an example wireless communications system.

FIG. 2 is a block diagram of components of an example user equipment shown in FIG. 1.

FIG. 3 is a block diagram of components of an example transmission/reception point shown in FIG. 1.

FIG. 4 is a block diagram of components of an example server shown in FIG. 1.

FIG. 5 is a block diagram illustrating entities in a system capable of determining the location of a user equipment (UE).

FIG. 6 is a signaling flow illustrating various messages between components of the communication system including a UE recommendation or request for positioning technologies and methods.

FIG. 7 is a signaling flow illustrating a capability transfer procedure between a UE and a location server in which a UE may provide a recommendation or request for positioning technologies and methods.

FIG. 8 is a signaling flow illustrating a provide priority procedure between a UE and a location server to provide a UE recommendation or request for positioning technologies and methods.

FIG. 9 is a signaling flow illustrating an assistance data transfer procedure between a UE and a location server in which a UE may provide a recommendation or request for positioning technologies and methods.

FIG. 10 is a signaling flow illustrating location information transfer procedure between a UE and a location server in which a UE may provide a recommendation or request for positioning technologies and methods.

FIG. 11 is a flowchart for an exemplary method for supporting position determination of a UE in which a UE may provide a recommendation or request for positioning technologies and methods and that is performed by the UE.

FIG. 12 is a flowchart for an exemplary method for supporting position determination of a UE in which a UE may provide a recommendation or request for positioning technologies and methods and that is performed by the location server.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c etc. When referring to such an element using only the first number, any instance of the element is to be understood (e.g. element 110 in the previous example would refer to elements 110-1, 110-2 and 110-3 or to elements 110a, 110b and 110c).

### DETAILED DESCRIPTION

Implementations are described herein for a user equipment (UE) based prioritization and reporting of positioning technologies and methods. For example, a UE may provide recommendation or request one or more specific positioning technologies, one or more specific methods of a positioning technology, a combination thereof. In some implementations, the recommendation or request may be in the form of a priority list or ordering of positioning technologies and methods to be activated.

Items and/or techniques described herein may provide one or more of the following capabilities, as well as other capabilities not mentioned. Accuracy of an estimated location of a UE may be improved. An estimated location of a UE may be determined using positioning technologies and methods that are suitable for a current environment in which the UE is located, thereby improving accuracy as well as latency. Moreover, by limiting a positioning session to more suitable positioning technologies and methods as determined by the UE, overhead may be reduced. Other capabilities may be provided and not every implementation according to the disclosure must provide any, let alone all, of the capabilities discussed.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

Determining the location of a UE, sometimes referred to as positioning, accessing a wireless network is useful for many applications including, for example, emergency calls, personal navigation, asset tracking, locating a friend or family member, etc. There are now many different positioning technologies and methods that may be used for positioning of a UE. Existing positioning technologies, for example, may be based on measuring radio signals transmitted from a variety of devices or entities including satellite vehicles (SVs) and terrestrial radio sources in a wireless network such as base stations and access points, for internal sensors.

For example, UEs may be positioned using a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Another positioning technology is based on internal sensors within the UE, including e.g., inertial sensors such as accelerometers and gyroscopes, and barometric sensors. Additionally, signaling between a UE and terrestrial base stations, access points, and/or other UEs in sidelink (SL) channels are other examples of positioning technologies that may be used for positioning of a UE. For example, a UE may use signaling with a Wireless Local Area Network (WLAN), such as WiFi, WiFi-Direct (WiFi-D), Bluetooth®, Bluetooth®-low energy (BLE), Zigbee, etc., for position determination. A UE may further use signaling with a Wireless Wide Area Network (WWAN) for position determination. For example, one example of a WWAN positioning technology is Long Term Evolution (LTE), while another example is Fifth Generation New Radio (5G NR).

Within different types of positioning technologies, there may be several different types of positioning methods available to a UE. Some positioning methods may be available in different positioning technologies. For example, SPS may use Assisted GNSS (A-GNSS), which may be mobile station assisted (MSA) mode or mobile station based (MSB) mode. Sensors may use positioning methods such as dead reckoning or sensor assisted positioning. WLAN positioning may use various positioning methods, e.g., based on RSRP (reference signal received power) measurements. LTE positioning methods may include, for example, Observed Time Difference of Arrival (OTDOA), A-GNSS, Enhanced Cell ID (E-CID). Additionally, 5G NR may include positioning methods that include downlink (DL) only, uplink (UL) only, DL and UL, and SL based positioning methods. For example, DL based positioning methods include, e.g., DL Time Difference of Arrival (DL-TDOA), DL Angle of Departure (DL-AoD). Uplink based positioning method include, e.g., UL-TDOA and UL Angle of Arrival (UL-AoA). Combined DL and UL based positioning included, e.g., round-trip time (RTT), which may be with one or more neighboring base stations (multi-RTT). Further SL with other UEs or with one or more base stations (e.g., a serving base station) combined with SL with other UEs may be used for multi-RTT. Further, E-CID measurements are supported by 5G NR. Other positioning techniques and positioning methods may additionally be used by a UE for positioning.

Currently, the positioning technology and methods to be used by a UE during a positioning session are provided by the location server, e.g., in a message carrying positioning assistance data or the request for location information. The UE, however, may be in a better position than a remote location server to determine which positioning technologies and methods are more suitable for position determination. There is no mechanism in current positioning protocols, however, for a UE to provide a recommendation for positioning technologies and methods to a location server.

Implementations are described herein for a user equipment (UE) based prioritization and reporting of positioning technologies and methods. A UE may provide a recommendation or request for one or more specific positioning technologies, one or more specific methods of a positioning technology, a combination thereof, that may be more appropriate for the environment in which the UE is located. In some implementations, the recommendation or request may be in the form of a priority list or ordering of positioning technologies and methods to be activated. The UE based prioritization and reporting of positioning technologies and methods may be provided as part of a message used in current positioning protocols, such as in a provide capabilities message, a request for assistance data message, a provide location information message, or may be part of a new type of message.

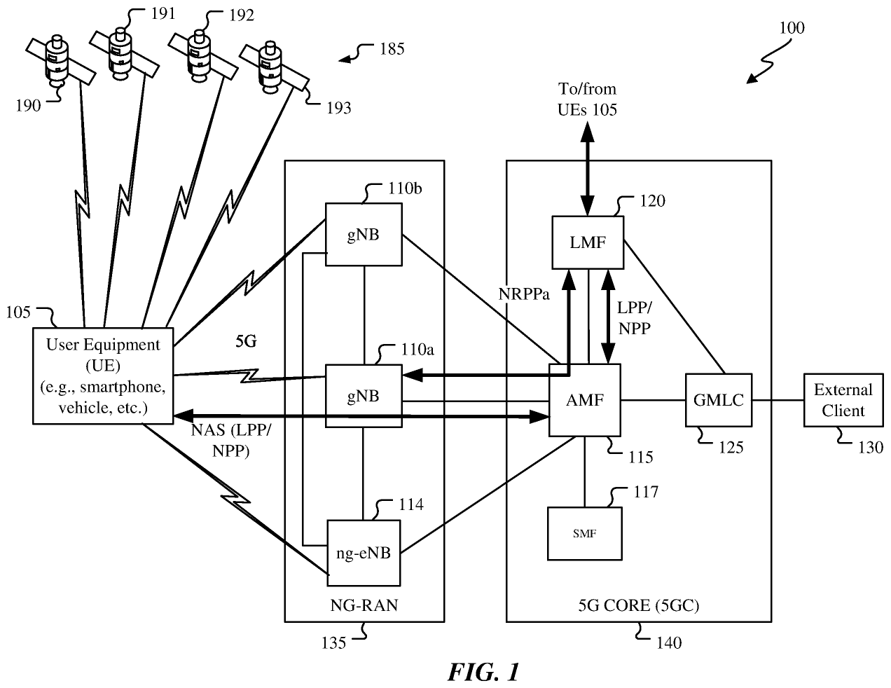

FIG. 1 shows an example of a communication system 100 that includes a UE 105, a Radio Access Network (RAN) 135, here a Fifth Generation (5G) Next Generation (NG) RAN (NG-RAN), and a 5G Core Network (5GC) 140. The UE 105 may be, e.g., an IoT device, a location tracker device, a cellular telephone, a vehicle, or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. The BSs 110a, 110b, 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more of the BSs 110a, 110b, 114 may be configured to communicate with the UE 105 via multiple carriers. Each of the BSs 110a, 110b, 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although only one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication and components of the system 100 can communicate with one another (at least some times using wireless connections) directly or indirectly, e.g., via the BSs 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples only as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the BSs 110a, 110b, 114, the core network 140, and/or the external client 130. For example, such other devices may include internet of thing (IoT) devices, medical devices, home entertainment and/or automation devices, etc. The core network 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs 110a, 110b, 114 may each comprise one or more TRPs. For example, each sector within a cell of a BS may comprise a TRP, although multiple TRPs may share one or more components (e.g., share a processor but have separate antennas). The system 100 may include only macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the BSs 110a, 110b, 114. The LMF 120 may support positioning of the UE 105 when the UE 105 accesses the NG-RAN 135 and may support positioning technologies and methods such as Assisted GNSS (A-GNSS), Observed Time Difference of Arrival (OTDOA) (e.g., Downlink (DL) OTDOA or Uplink (UL) OTDOA), Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the core network 140, and provides QoS (Quality of Service) flow and session management. The AMF 115 may support mobility of the UE 105 including cell change and handover and may participate in supporting signaling connection to the UE 105.

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though only one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time Of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

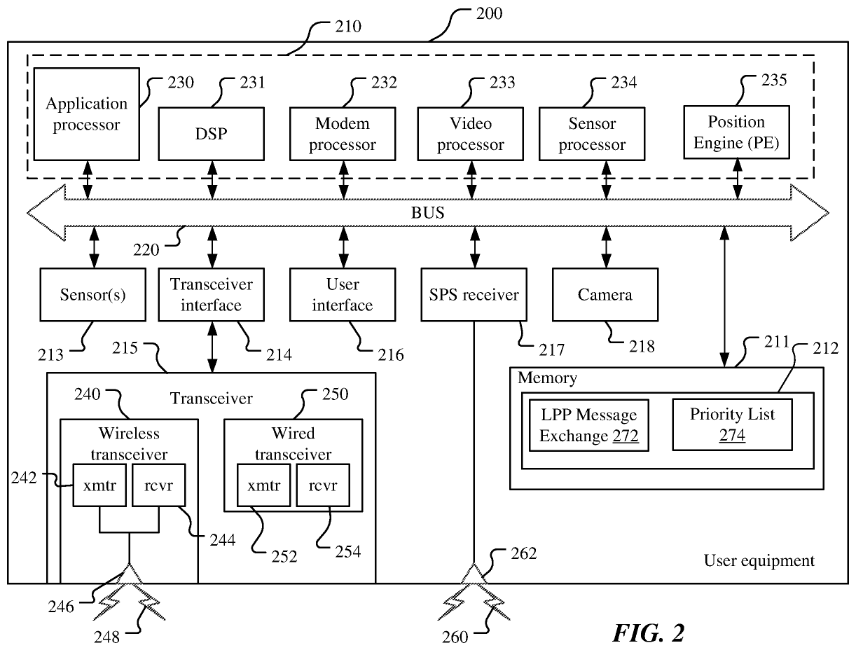

FIG. 2 illustrates a UE 200, which is an example of the UE 105 and comprises a computing platform including a processor 210, memory 211 including software (SW) 212, one or more sensors 213, a transceiver interface 214 for a transceiver 215, a user interface 216, a Satellite Positioning System (SPS) receiver 217, a camera 218, and a position engine (PE) 235, which may be part of the processor 210. The processor 210, the memory 211, the sensor(s) 213, the transceiver interface 214, the user interface 216, the SPS receiver 217, the camera 218, and the position engine 235 may be communicatively coupled to each other by a bus 220 (which may be configured, e.g., for optical and/or electrical communication). One or more of the shown apparatus (e.g., the camera 218, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including an application processor 230, a Digital Signal Processor (DSP) 231, a modem processor 232, a video processor 233, a sensor processor 234, and the PE 235. One or more of the processors 230-235 may comprise multiple devices (e.g., multiple processors). For example, the sensor processor 234 may comprise, e.g., processors for radar, ultrasound, and/or lidar, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to operate as a special purpose computer programmed to perform the various functions described herein. Alternatively, the software 212 may not be directly executable by the processor 210 but may be configured to cause the processor 210, e.g., when compiled and executed, to operate as a special purpose computer to perform the various functions described herein. The description may refer only to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the present disclosure, including the claims, and other configurations may be used. For example, an example configuration of the UE includes one or more of the processors 230-234 of the processor 210, the memory 211, and the wireless transceiver 240. Other example configurations include one or more of the processors 230-235 of the processor 210, the memory 211, the wireless transceiver 240, and one or more of the sensor(s) 213, the user interface 216, the SPS receiver 217, the camera 218, the PE 235, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more barometric pressure sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes. The sensor(s) 213 may include one or more magnetometers to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s), the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer may be a two-dimensional magnetometer configured to detect and provide indications of magnetic field strength in two orthogonal dimensions. Alternatively, the magnetometer may be a three-dimensional magnetometer configured to detect and provide indications of magnetic field strength in three orthogonal dimensions. The magnetometer may provide means for sensing a magnetic field and providing indications of the magnetic field, e.g., to the processor 210.

The barometric pressure sensors(s) may determine air pressure, which may be used to determine the elevation or current floor level in a building of the UE 200. For example, a differential pressure reading may be used to detect when the UE 200 has changed floor levels as well as the number of floors that have changed. The barometric pressure sensors(s) may provide means for sensing air pressure and providing indications of the air pressure, e.g., to the processor 210.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a transmitter 252 and a receiver 254 configured for wired communication, e.g., with the network 135. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The processor 230, the memory 211, the DSP 231, the PE 235 and/or one or more additional specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, the PE 235, and/or one or more additional specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position engine (PE) 235 may be configured to determine a position of the UE 200, motion of the UE 200, and/or relative position of the UE 200, and/or time. For example, the PE 235 may communicate with, and/or include some or all of, the SPS receiver 217. The PE 235 may be part of or work in conjunction with the processor 210 and the memory 211 as appropriate to perform at least a portion of one or more positioning methods, although the description herein may refer only to the PE 235 being configured to perform, or performing, in accordance with the positioning method(s). The PE 235 may also or alternatively be configured to determine location of the UE 200 using terrestrial-based signals (e.g., at least some of the signals 248) for trilateration, for assistance with obtaining and using the SPS signals 260, or both. The PE 235 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PE 235 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PE 235 may be configured to provide indications of uncertainty and/or error in the determined position and/or motion.

The memory 211 may store software 212 that contains executable program code or software instructions that when executed by the processor 210 may cause the processor 210 to operate as a special purpose computer programmed to perform the functions disclosed herein. As illustrated, the memory 211 may include one or more components or modules that may be implemented by the processor 210 to perform the disclosed functions. While the components or modules are illustrated as software 212 in memory 211 that is executable by the processor 210, it should be understood that the components or modules may be stored in another computer readable medium or may be dedicated hardware either in the processor 210 or off the processor. A number of software modules and data tables may reside in the memory 211 and be utilized by the processor 210 in order to manage both communications and the functionality described herein. It should be appreciated that the organization of the contents of the memory 211 as shown is merely exemplary, and as such the functionality of the modules and/or data structures may be combined, separated, and/or be structured in different ways depending upon the implementation.

The memory 211, for example, may include an LPP message exchange module 272 that when implemented by the processor 210 configures the processor 210 to receive from and transmit to a location server one or more messages according to LPP, including Request Capabilities; Provide Capabilities; Request Priority, Provide Priority, Request Assistance Data; Provide Assistance Data; Request Location Information; Provide Location Information; Abort; and Error.

The memory 211 may further include, for example, a priority list module 274 that when implemented by the processor 210 configures the processor 210 to determine a recommendation or request for positioning techniques and/or methods and to provide the recommendation or request as a priority list of one or more specific positioning technologies, one or more specific methods of a positioning technology, or a combination thereof in one or more of the LPP messages, either unsolicited or in response to a request, in a common information element (IE) field or by ranking IEs associated with different positioning techniques and methods.

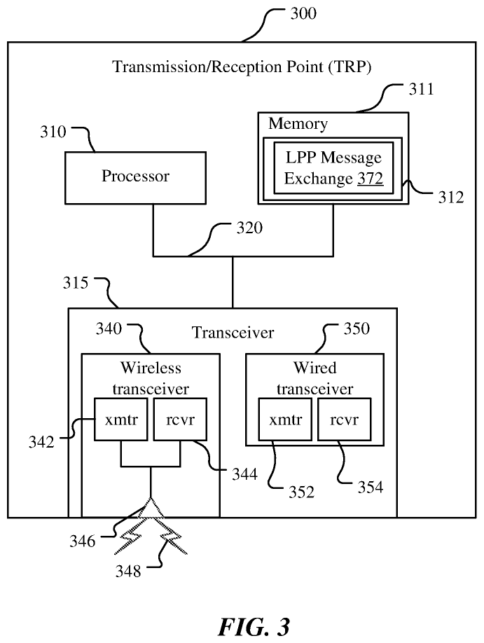

FIG. 3 shows an example of a TRP 300 of the BSs 110a, 110b, 114 that comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including one or more of an application processor, a DSP, a modem processor, a video processor, and/or a sensor processor, similar to that shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to operate as a special purpose computer programmed to perform the various functions described herein. Alternatively, the software 312 may not be directly executable by the processor 310 but may be configured to cause the processor 310, e.g., when compiled and executed, to operate as a special purpose computer to perform the various functions described herein. The description may refer only to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 135 to send communications to, and receive communications from, the LMF 120, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the present disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

The memory 311 may store software 312 that contains executable program code or software instructions that when executed by the processor 310 may cause the processor 310 to operate as a special purpose computer programmed to perform the functions disclosed herein. As illustrated, the memory 311 may include one or more components or modules that may be implemented by the processor 310 to perform the disclosed functions. While the components or modules are illustrated as software 312 in memory 311 that is executable by the processor 310, it should be understood that the components or modules may be stored in another computer readable medium or may be dedicated hardware either in the processor 310 or off the processor. A number of software modules and data tables may reside in the memory 311 and be utilized by the processor 310 in order to manage both communications and the functionality described herein. It should be appreciated that the organization of the contents of the memory 311 as shown is merely exemplary, and as such the functionality of the modules and/or data structures may be combined, separated, and/or be structured in different ways depending upon the implementation.

The memory 311, for example, may include an LPP message exchange module 372 that when implemented by the processor 310 configures the processor 310 to receive and transmit between the UE and location server one or more messages according to LPP, including Request Capabilities; Provide Capabilities; Request Priority, Provide Priority, Request Assistance Data; Provide Assistance Data; Request Location Information; Provide Location Information; Abort; and Error.

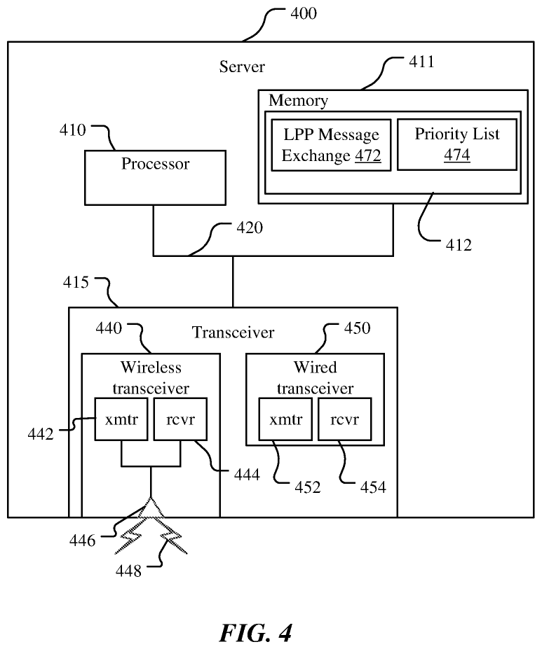

FIG. 4 shows a server 400, which is an example of the LMF 120, that comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including at least one of an application processor, a DSP, a modem processor, a video processor, and/or a sensor processor, similar to that shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to operate as a special purpose computer programmed to perform the various functions described herein. Alternatively, the software 412 may not be directly executable by the processor 410 but may be configured to cause the processor 410, e.g., when compiled and executed, to operate as a special purpose computer to perform the various functions described herein. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., with the network 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the present disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

The memory 411 may store software 412 that contains executable program code or software instructions that when executed by the processor 410 may cause the processor 410 to operate as a special purpose computer programmed to perform the functions disclosed herein. As illustrated, the memory 411 may include one or more components or modules that may be implemented by the processor 410 to perform the disclosed functions. While the components or modules are illustrated as software 412 in memory 411 that is executable by the processor 410, it should be understood that the components or modules may be stored in another computer readable medium or may be dedicated hardware either in the processor 410 or off the processor. A number of software modules and data tables may reside in the memory 411 and be utilized by the processor 410 in order to manage both communications and the functionality described herein. It should be appreciated that the organization of the contents of the memory 411 as shown is merely exemplary, and as such the functionality of the modules and/or data structures may be combined, separated, and/or be structured in different ways depending upon the implementation.

The memory 411, for example, may include an LPP message exchange module 472 that when implemented by the processor 410 configures the processor 410 to receive from and transmit to a UE one or more messages according to LPP, including Request Capabilities; Provide Capabilities; Request Priority, Provide Priority, Request Assistance Data; Provide Assistance Data; Request Location Information; Provide Location Information; Abort; and Error.

The memory 411 may further include, for example, a priority list module 474 that when implemented b by the processor 410 configures the processor 410 to receive a recommendation or request for positioning techniques and/or methods from a UE, e.g., in the form of a priority list of one or more specific positioning technologies, one or more specific methods of a positioning technology, or a combination thereof in one or more of the LPP messages in a common information element (IE) field or by ranking IEs associated with different positioning techniques and methods. The processor 410 may be configured to request the priority list from the UE or to receive the priority list unsolicited from the UE. The processor 410 may be further configured to accept, modify or reject the priority list and to configure positioning methods, e.g., in assistance data and PRS configurations, in a current or subsequent positioning session based on the receive priority list.

For terrestrial positioning of a UE, cellular technologies, such as LTE and 5G NR may use techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning. Additionally, a terrestrial beacon system (TBS) may be employed, in which a network or wide area of beacons operate in a manner similar to SPS, enabling receivers to use trilateration to determine a precise location. Other terrestrial based techniques, for example, include use of WLAN technologies such as WiFi and Blue-Tooth®, and sensors on board the UE.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that only the UEs subscribed to the service can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix.

Thus, one or more of many different positioning technologies may be used to determine position of an entity such as the UEs 105. For example, positioning technologies that may be used include one or more of LTE, 5G NR, SL positioning, SPS, sensors, TBS, WLAN, and Blue-Tooth®. One or more of many different positioning techniques (also called positioning methods) may be used to determine position of an entity such as the UEs 105. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs, other UEs (in SL channel) or both) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). RTT may further be performed using other UEs, e.g., in SL channel, or a combination of base stations and other UEs, but for the sake of simplicity may be described herein with reference to base stations. The one of more base stations transmit RTT measurement signals on low use resources (e.g., resources used by the base station to transmit system information) allocated by the network (e.g., the location server 120 such as a Location Management Function (LMF)). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal.

Positioning reference signals (PRS) include downlink PRS (DL PRS) and uplink PRS (UL PRS) (which may be called SRS (Sounding Reference Signal) for positioning). PRS may comprise PRS resources or PRS resource sets of a frequency layer. A DL PRS positioning frequency layer (or simply a frequency layer) is a collection of DL PRS resource sets, from one or more TRPs, that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb-size.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple Resource Elements (REs) that can span multiple Physical Resource Blocks (PRBs) within N (one or more) consecutive symbol(s) within a slot. A PRB is a collection of REs spanning a quantity of consecutive symbols in the time domain and a quantity of consecutive sub-carriers in the frequency domain. In an OFDM symbol, a PRS resource occupies consecutive PRBs. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting patter configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS that is received by multiple TRPs instead of sending a separate UL-SRS for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS signal in a PRS/SRS signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS signal pair may be transmitted from the TRP and the UE, respectively, within about 10 ms of each other. With SRS signals being sent by UEs, and with PRS and SRS signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL and UL positioning methods. Downlink-based positioning methods include DL-TDOA and DL-AoD. Uplink-based positioning methods include UL-TDOA and UL-AoA. Combined DL and UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

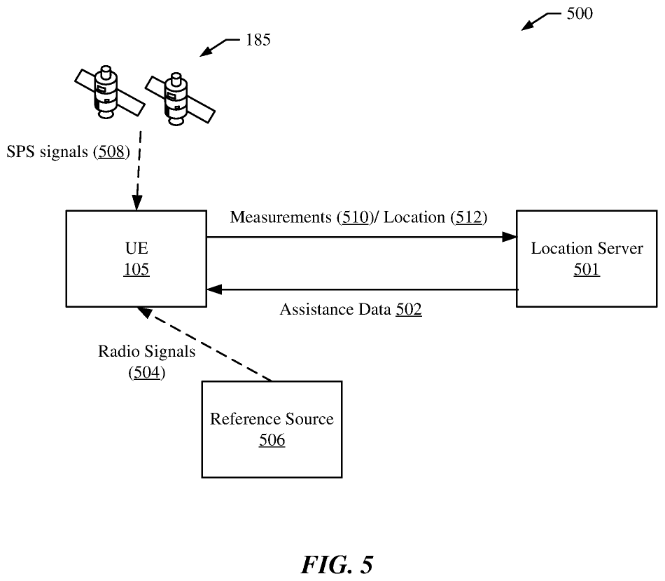

FIG. 5 shows a simplified block diagram illustrating some entities in a system 500 capable of determining the location of UE 105. Referring to FIG. 5, location server 501, which may be, e.g., LMF 120 shown in FIG. 1, an E-SMLC, or SLP, may provide location assistance data 502 to UE 105, e.g., via base station 110 shown in FIG. 1, which may be used to assist UE 105 in acquiring and measuring radio signals 504 from reference source(s) 506 (e.g. which may one or more TRPs or base stations (eNB, gNB, ng-eNB), or access points) and/or SPS signals 508 from SPS 185 to produce measurements 510. The assistance data 502 may additionally or alternatively be used to derive or refine a location estimate 512 from measurements 510. Location assistance data 502 may include base station almanac (BSA) data for nearby TRPs 110 such as cell identities, TP identities, DL PRS/NPRS signal characteristics, transmission timing, antenna coordinates, and/or approximate expected RSTD measurements. Location assistance data 502 may also or instead include information for SPS 185 such as timing and ephemeris data.

The location server 501 and the UE 105 may communicate point-to-point using LPP, which may be defined in 3GPP TS 36.355. LPP may be used in order to position the target UE 105 using position-related measurements obtained by the one or more reference sources 506 and 185. LPP, for example, may be used in control-plane and user-plane location solutions for E-UTRAN and NG-RAN, e.g., as defined in 3GPP TS 36.305, TS 38.305, TS 23.273, and TS 23.271.

Internal LPP positioning methods and associated signaling content are defined in the LPP. For example, the specification defines OTDOA (based on LTE signals), A-GNSS, E-CID (based on LTE signals), Sensor, TBS, WLAN, Bluetooth, NR E-CID, NR DL-TDOA, NR DL-AOD and NR Multi-RTT positioning methods.

An LPP transaction involves the exchange, e.g., transmission and reception, of one or more LPP messages between a location server, e.g., LMF 120, and a target device, e.g., UE 105. The general format of an LPP message consists of a set of common fields followed by a body. The body (which may be empty) contains information specific to a particular message type. Each message type contains information specific to one or more positioning methods and/or information common to all positioning methods.

The following message types are defined for LPP: Request Capabilities; Provide Capabilities; Request Assistance Data; Provide Assistance Data; Request Location Information; Provide Location Information; Abort; Error.

For example, in an LPP call flow for OTDOA according to current design, a UE sends all NR/LTE BAND Capabilities and current serving cell information to the location server, and, in response, receives adequate assistance data from the location server. The UE then starts decoding all data and requests Lower layers to start decoding PRS signal. The UE will consume more power to decode all signals over the physical channel and return the data to the OTDOA module. For example, if the OTDOA is not the right technology to be used, then the UE spends unnecessary power to read the assistance data, process PRS, etc.

In an AGNSS call flow, for example, the UE sends all Constellations capabilities to the location server and receives the assistance data from the location server before starting the SPS engine, which consumes more power. In a mobile station assist (MSA) mode, the UE sends satellite vehicle CNo values to the location sever based on the assistance data received from the location server. In this case, the Measurement engine (ME module) is activated to decode the satellite vehicle's data and return the data back to the Session manager module. In a mobile station based (MSB) mode, the Position engine (PE module) is additionally enabled, which consumes more power. The UE reports the latitude and longitude values to location server with all details. The accuracy of the Assistance Data, such as Reference time and Location along with Ephemeris/Almanac, in the MSB mode is of particular importance. If AGNSS is not the right technology to be used, then the UE spends unnecessary power.

In indoor positioning, for example, if the UE is in a parking garage or in an indoor location such as a shopping mall, cinema, etc., the UE may have substantially less visibility of satellite vehicle or RAT signals. As a result, attempts to use SPS or cellular signals for positioning may suffer from jamming and interference. In this situation, if GNSS or OTDOA modules are active to calculate a position fix, the UE will consume more power and any resulting position will have high error with high of uncertainty. Further, the fix time will be increased, e.g., a GNSS fix may take more than 20 sec, which in some circumstances, e.g., E911 and MO app track concurrency, may be considered unacceptable.

The location server 120 conventionally provides the positioning technology and methods to be used by a UE during a positioning session in an LPP message, such as the Provide Assistance Data and/or Request Location Information. The UE 105, however, may be in a better position to determine which positioning technologies and methods are more suitable for position determination in the environment in which the UE 105 is located. For example, the UE 105 may be able to determine which positioning technologies, e.g., LTE, 5G NR, sidelink positioning, SPS, etc. are available to the UE 105, and which positioning methods may be more suitable, for example, based on the number of reference sources visible to the UE 105 and their signal characteristics. Other factors that may be used to determine which positioning methods may be more suitable include long term wireless channel characteristics, existence/activation of other sensors, power saving/battery state of the UE, previous measurement derivation, and Quality of Service parameters (e.g. response time, accuracy, horizontal or horizontal and vertical location request).

Accordingly, in some implementations as described herein, the UE may provide a recommendation or request to a location server of one or more specific positioning technologies, one or more specific methods of a positioning technology, or a combination thereof. The recommendation or request, for example, may be in the form of a priority list or ordering of positioning technologies and methods to be activated. The UE based prioritization and reporting of positioning technologies and methods may be provided as part of an LPP message or other type of message, such as in a provide capabilities message, a request for assistance data message, a provide location information message, or may be part of a new type of message.

For example, in one implementation, the UE may provide a recommendation or request of a specific positioning technology, a specific positioning method of a positioning technology, or a combination of technologies and methods. The UE may provide a recommendation or request in the form of a priority list or ordering of which technology or method should be activated.

The UE recommendation or request may be, e.g., a separate transaction in the LPP functionality. In another implementation, the UE recommendation or request may be, e.g., part of the “Provide Location Information” message, for example, where the UE is configured with multiple positioning sessions, technologies, or reporting. For example, based on measurements in a positioning session, the UE can determine that some of the technologies or methods are not efficient or are not useful, and may provide a recommendation or request for appropriate technologies or methods to the LMF in the provide location information message. In another implementation, the UE recommendation or request may be, e.g., part of the “Request of Assistance data,” in which the UE may request of assistance data of multiple technologies, but may include a priority for each technology or method. In another implementation, the UE recommendation or request may be, e.g., part of the “Provide Capabilities” message, where the UE provides capabilities of multiple technologies, but includes a priority for each technology or method to the LMF. In some implementations, one, all or a combination for the foregoing may be used.

In one implementation, the recommendation or request from the UE 105 for positioning technologies, or methods may be in a new transaction, e.g., which may be referred to as a provide priority message. The provide priority message may be unsolicited or in response to a request. The provide priority message may include which positioning technologies, or methods are requested or recommended to be used by the UE, which may be a priority list of technologies, or methods, or combination thereof. In some examples, the provide priority message may be in response to a “Request” from the LMF to the UE, in which the LMF requests that the UE provides recommendations or suggestions positioning technologies or methods.

In one implementation, the recommendation or request from the UE 105 for positioning technologies or methods may be part of the “Request of Assistance data”, in which the UE requests assistance data. For example, inside the CommonIEsRequestAssistanceData, a priority can be introduced with which the UE suggests which Assistance data should be delivered to the UE. Alternatively, a priority may be provided by ranking IEs associated with different positioning technologies or methods.

In one implementation, the recommendation or request from the UE 105 for positioning technologies or methods may be part of the “Provide of Capabilities”, in which the UE provides capabilities. For example, inside the CommonIEsProvideCapabilities, the priority of positioning technologies or methods may be introduced. Alternatively, a priority may be provided by ranking IEs associated with different positioning technologies or methods.

All or a subset of the of the foregoing may be used by the UE to recommend a positioning technology or method.

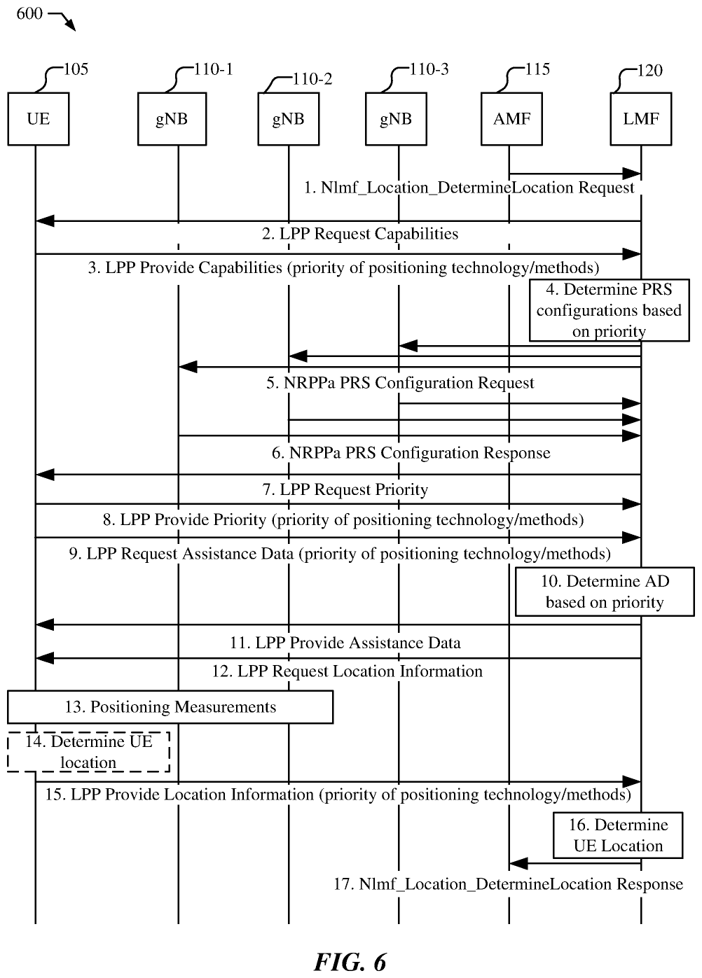

FIG. 6 shows a signaling flow 600 that illustrates various messages sent between components of the communication system 100 depicted in FIG. 1, during a location session between the UE 105 and the LMF 120. While the flow diagram is discussed, for ease of illustration, in relation to a 5G NR wireless access using gNBs 110, signaling flows similar to FIG. 6 involving ng-eNBs 114 or eNBs rather than gNBs 110 will be readily apparent to those with ordinary skill in the art. Furthermore, in some embodiments, the UE 105 itself may be configured to determine its location using, for example, assistance data provided to it. In the signaling flow 600, it is assumed that the UE 105 and LMF 120 communicate using the LPP positioning protocol referred to earlier, although use of NPP or a combination of LPP and NPP is also possible.

FIG. 6 illustrates a procedure in which the UE 105 may provide a recommendation or request, which may be in the form of a priority list or ordering, for positioning technologies and methods to be activated during a current or future positioning session. The recommendation or request from the UE 105 may be included, for example, in the body or in a common field of one or more LPP messages. It should be understood that the priority list of the one or more positioning technologies, positioning methods or combination thereof may be provided by the UE 105 at any one or more of the messages. FIG. 6, for example, illustrates a priority list of the one or more positioning technologies, positioning methods or combination thereof provided by the UE 105 in any one or more of the Provide Capabilities message at stage 3, Provide Priority message at stage 8, Request Assistance Data message at stage 9, or the Provide Location information message at stage 15, but it should be understood that the priority list may be sent in all or only a subset of these messages. The location server 120 may accept, modify, or reject the positioning technology and/or method recommendation or request from the UE 105.

At stage 1 in FIG. 6, the serving AMF 115 for a UE 105 invokes an Nlmf_location_DetermineLocation service operation towards the LMF 120 to request the current location of the UE 105. The service operation includes the serving cell identity, the LCS client type and may include a required Quality of Service (QoS). For example, AMF 115 may perform stage 1 in response to receiving a location request for UE 105 from GMLC 125.

At stage 2, the LMF 120 sends an LPP Request Capabilities message to the UE 105 to request the positioning capabilities of the UE 105. The Request Capabilities message to the UE 105 may include a request for a priority of positioning technologies and methods from the UE 105. In one implementation, the request for a priority of positioning technologies and methods may request an ordered list of positioning technologies and methods based on preference.

At stage 3, the UE 105 returns an LPP Provide Capabilities message to the LMF 120 to provide the positioning capabilities of the UE 105. The positioning capabilities may include the radio signal, SPS signal and sensor measurement capabilities of the UE 105. The UE 105 may include a priority list of the one or more positioning technologies, positioning methods or combination thereof for the positioning session in the LPP Provide Capabilities message. The priority list may indicate a priority, e.g., a ranking, in a common IE or in one or more separate IEs associated with the one or more positioning technologies, positioning methods or combination thereof in the LPP Provide Capabilities message.

At stage 4, the LMF 120 may determine PRS configurations (if appropriate) using the priority list of the one or more positioning technologies, positioning methods or combination thereof provided by the UE 105 at stage 3. By way of example, the LMF 120 may accept, modify or reject the priority list provided by the UE 105. If the LMF 120 accepts or modifies the priority list provide by the UE, the LMF 120 may generate PRS configurations for the appropriate positioning technology and positioning method based on the priority list provided by the UE 105. For example, if the UE 105 recommends particular positioning technology, the LMF 120 may generate PRS configurations based on appropriate positioning methods for that positioning technology. If the UE 105 recommends particular positioning methods, the LMF 120 may generate PRS configurations based on appropriate the positioning method using one or more positioning technologies.

At stage 5, the LMF 120 optionally sends an NRPPa PRS Configuration Request message to each of the gNBs 110 generated at stage 4.

At step 6, if stage 5 occurs, each of the gNBs 110 returns a response to the LMF 120 indicating whether the PRS configuration can be supported. If some gNBs 110 indicate that the PRS configuration cannot be supported, the LMF 120 may perform stage 4 a second time to determine appropriate AD and PRS configurations.

At stage 7, the LMF 120 may optionally send an LPP Request Priority message to the UE 105 to specifically request that the UE 105 provide a priority of positioning technologies and methods as recommended from the UE 105.

At stage 8, the UE 105 may send an LPP Provide Priority message to the LMF 120 to provide a recommendation or request for positioning technologies and methods to be activated during the positioning session. In some implementations, the LPP Provide Priority message may be unsolicited. The UE 105 may provide a priority list of the one or more positioning technologies, positioning methods or combination thereof for the positioning session in the LPP Provide Priority message. The recommendation or request from the UE 105 may be included, for example, in the body or in a common field of one or more LPP messages. It should be understood that stage 7 and stage 8 (if used) may be performed at other times during the signaling flow 600.

At stage 9, the UE 105 sends an LPP Request Assistance Data message to the LMF 120 to request AD from the LMF 120. The UE 105 may include a priority list of the one or more positioning technologies, positioning methods or combination thereof for the positioning session in the LPP Request Assistance Data message. The priority list may indicate a priority, e.g., a ranking, in a common IE or in one or more separate IEs associated with the one or more positioning technologies, positioning methods or combination thereof in the LPP Request Assistance Data message.

At stage 10, the LMF 120 may determine assistance data (AD) using the priority list of the one or more positioning technologies, positioning methods or combination thereof provided by the UE 105 at one or more of stages 9, 8, or 3. In some implementations, stage 10 may be combined with stage 3, e.g., if the priority list of the one or more positioning technologies, positioning methods or combination thereof was provided by the UE 105 in the Provide Capabilities message at stage 3 and no Provide Priority message at stage 8 or Request Assistance Data message at stage 9 are used. The LMF 120 may accept, modify or reject the priority list provided by the UE 105. If the LMF 120 accepts or modifies the priority list provide by the UE, the LMF 120 may generate or identify AD associated with the appropriate positioning technology and positioning method based on the priority list provided by the UE 105. For example, if the UE 105 recommends particular positioning technology, the LMF 120 may generate AD based on appropriate positioning methods for that positioning technology. If the UE 105 recommends particular positioning methods, the LMF 120 may generate AD based on appropriate the positioning method using one or more positioning technologies. The LMF 120 may include information in the AD for positioning reference signals transmitted by the serving gNB 110-1 and neighbor gNBs 110 in the wireless network and/or reference time and location along with Ephemeris/Almanac for an SPS based on the priority of the positioning technologies and positioning methods.

At stage 11, the LMF 120 sends an LPP Provide Assistance Data message to the UE 105 to provide the AD determined at stage 8. For example, the LPP Provide Assistances Data message may be forwarded to the UE 105 by the serving gNB 110-1 and AMF 115. The AD may further include, e.g., location information for the gNBs 110 and other information useful for UE based positioning.

At stage 12, the LMF 120 sends an LPP Request Location Information message to the UE 105 to request the UE 105 perform positioning measurements, which may be based on the priority list of the one or more positioning technologies, positioning methods or combination thereof provided by the UE 105. For example, the LMF 120 may include in the LPP Request Location Information message a request for location measurements for one or more positioning technologies, such as LTE, 5G NR, sidelink positioning, SPS, sensors, TBS, WLAN (such as WiFi) and Blue-Tooth®. The LMF 120 may include in the LPP Request Location Information message a request for location measurements for one or more positioning methods, such measurements for as DL TDOA, DL AOD, UL TDOA, UL AOA, RTT, multi-RTT, E-CID, UE based SPS, UE assisted SPS, inertial sensors and barometric sensors. For some positioning methods (e.g. multi-RTT), the LMF 120 may also request UE 105 to transmit an uplink (UL) PRS, UL Sounding Reference Signal (SRS), or SL reference signals, and may request one or more gNBs 110, or other UEs, to obtain UL measurements (e.g. RxTx, AOA, TOA and/or RSRP) of the UL PRS, UL SRS, or SL reference signals.

At stage 13, the UE 105 performs the positioning measurements requested in the Request Location Information message at stage 12, e.g., including radio signal measurements, SPS measurements, and sensor measurements. In some implementations, e.g., where the UE 105 is configured with multiple positioning sessions, positioning technologies and methods, the UE 105 may determine that some of the positioning technologies or methods are not efficient or useful. For example, the UE 105 may determine that some of the some of the positioning technologies or methods have poor Signal to Noise (SNR) ratio or require an inordinate amount of time to acquire. Other factors that may be used to determine which positioning methods may be more suitable include long term wireless channel characteristics, existence/activation of other sensors, power saving/battery state of the UE, previous measurement derivation, and Quality of Service parameters (e.g. response time, accuracy, horizontal or horizontal and vertical location request).

At stage 14, if UE 105 based positioning was requested at stage 12, the UE 105 may determine its location based on the positioning measurements obtained at stage 13 and the assistance data received at stage 11.

At stage 15, the UE 105 sends an LPP Provide Location Information message to the LMF 120 and includes the positioning measurements obtained at stage 13 and/or the location estimate determined at stage 14. Any UL measurements from the gNBs 110 may be to the LMF 120 directly from one or more of the gNBs 110 or through the UE 105. The UE 105 may additionally include in the Provide Location Information message a recommendation or request for positioning technologies and methods to be activated for a future session. For example, the UE 105 may provide a priority list of the one or more positioning technologies, positioning methods or combination thereof for a future positioning session, which may be based, e.g., on which positioning technologies or methods were determined to be more efficient or useful in stage 13 (if performed). For example, the LPP Provide Location Information message may be forwarded to the LMF 120 by the serving gNB 110-1.

At stage 16, the LMF 120 determines the UE location based on any positioning measurements received at stage 15 or may verify a UE location received at stage 15.

At stage 17, the LMF 120 returns an Nlmf_Location_DetermineLocation Response to the AMF 115 to return the location obtained at stage 13.

In some implementations, e.g., during a periodic positioning session or if the positioning measurements were determined not to be useful, the signal flow 600 may be repeated, with the LMF 120 using the priority list of the one or more positioning technologies, positioning methods or combination thereof received from the UE 105 in the Provide Location Information message in stage 15 to select the positioning technologies and/or methods used.

As discussed above, the priority list of the one or more positioning technologies, positioning methods or combination thereof provided by the UE 105 as a recommendation or request for the current or future positioning session may be included in any one or more of the Provide Capabilities message at stage 3, Provide Priority message at stage 8, Request Assistance Data message at stage 9, or the Provide Location information message at stage 15.

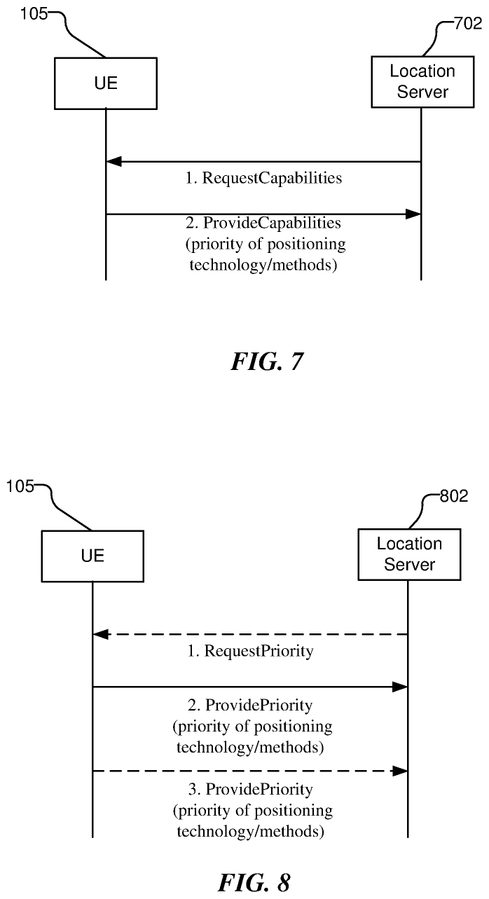

FIG. 7, for example, illustrates the LPP Capability Transfer procedure, in which the UE 105 may provide the priority list of the one or more positioning technologies, positioning methods or combination thereof to a location server 702, which may be, e.g., the LMF 120 or an E-SMLC, SLP, or other server. The Capability Transfer procedure enables the transfer of capabilities from a target device, e.g., UE 105, to the server, e.g., location server 702. Capabilities in this context refer to positioning and protocol capabilities related to LPP and the positioning methods supported by LPP. Additionally, the capabilities provides a mechanism with which the UE 105 may provide a recommendation or request for one or more positioning technologies and/or positioning methods.

At stage 1 of FIG. 7, the server 702 sends a RequestCapabilities message to the UE 105. The server 702 may indicate the types of capability needed. The server 702 may further indicate whether a priority list of the one or more positioning technologies, positioning methods or combination thereof is to be provided by the UE 105, if capable.

At stage 2 of FIG. 7, the UE 105 responds with a ProvideCapabilities message to the server 702. The capabilities may correspond to any capability types specified in stage 1. The ProvideCapabilities message may further include priority list of the one or more positioning technologies, positioning methods or combination thereof, e.g., in one or more IEs that correspond to different positioning technologies and methods in the body of the message or in a common IE. Table 1, below, for example, illustrates a ProvideCapabilities message, e.g., based on a fragment of Abstract Syntax Notation One (ASN.1), which shows the message body indicates the LPP capabilities of the UE 105 and includes a common IE, i.e., commonIEProvideCapabilities.

TABLE 1

| | |
|---|---|
| criticalExtensions | CHOICE { |

| | |
|---|---|
| cl | CHOICE { |
| provideCapabilities-r9 | ProvideCapabilities-r9-IEs, |

```
      spare3 NULL, spare2 NULL, spare1 NULL
    },
    criticalExtensionsFuture SEQUENCE { }
  }
}
ProvideCapabilities-r9-IEs ::= SEQUENCE {
```

| | |
|---|---|
| commonIEsProvideCapabilities | CommonIEsProvideCapabilities |

OPTIONAL, ...,

| | |
|---|---|
| a-gnss-ProvideCapabilities | A-GNSS-ProvideCapabilities |

OPTIONAL, ...,

| | |
|---|---|
| otdoa-ProvideCapabilities | OTDOA-ProvideCapabilities |

OPTIONAL, ...,

| | |
|---|---|
| ecid-ProvideCapabilities | ECID-ProvideCapabilities |

OPTIONAL, ...,

| | |
|---|---|
| epdu-ProvideCapabilities | EPDU-Sequence |

OPTIONAL, ...,

| | |
|---|---|
| [[ sensor-ProvideCapabilities-r13 | Sensor-ProvideCapabilities-r13 |

OPTIONAL, ...,

| | |
|---|---|
| tbs-ProvideCapabilities-r13 | TBS-ProvideCapabilities-r13 |

```
        OPTIONAL, ...,
    wlan-ProvideCapabilities-r13 WLAN-ProvideCapabilities-r13
        OPTIONAL, ...,
```

| | |
|---|---|
| bt-ProvideCapabilities-r13 | BT-ProvideCapabilities-r13 |

```
        OPTIONAL...,
  ]],
```

| | |
|---|---|
| [[ nr-ECID-ProvideCapabilities-r16 | NR-ECID-ProvideCapabilities-r16 |

```
        OPTIONAL, ...,
          nr-Multi-RTT-ProvideCapabilities-r16
```

NR-Multi-RTT-ProvideCapabilities -r16

```
        OPTIONAL, ...,
          nr-DL-AoD-ProvideCapabilities-r16
```

NR-DL-AoD-ProvideCapabilities-r16

```
        OPTIONAL, ...,
          nr-DL-TD0A-ProvideCapabilities-r16
```

NR-DL-TD0A-ProvideCapabilities-r16

```
        OPTIONAL, ...,
          nr-UL-ProvideCapabilities-r16
```

NR-UL-ProvideCapabilities-r16

```
        OPTIONAL ...,
  ]]
}
```

The priority list of the one or more positioning technologies, positioning methods or combination, for example, may be provided in the commonIEProvideCapabilities or the by ranking the individual IEs associated with the positioning technologies and positioning methods.

FIG. 8, for example, illustrates an LPP Provide Priority procedure, in which the UE 105 may provide the priority list of the one or more positioning technologies, positioning methods or combination thereof to a location server 802, which may be, e.g., the LMF 120 or an E-SMLC, SLP, or other server. The priority message may be provided in response to a request or unsolicited.

At stage 1 of FIG. 8, the server 802 may optionally send a RequestPriority message to the UE 105. The server 802, for example, may indicate whether a priority list of the one or more positioning technologies, positioning methods or combination thereof is to be provided by the UE 105, if capable.

At stage 2 of FIG. 8, the UE 105 may respond to the RequestPriority or may send unsolicited a ProvidePriority message to the server 802 that includes a priority list of the one or more positioning technologies, positioning methods or combination thereof, e.g., in one or more IEs that correspond to different positioning technologies and methods in the body of the message or in a common IE.

At stage 3 of FIG. 8, the UE 105 may optionally periodically send the ProvidePriority message to the server 802 that includes a priority list of the one or more positioning technologies, positioning methods or combination thereof, e.g., in one or more IEs that correspond to different positioning technologies and methods in the body of the message or in a common IE.

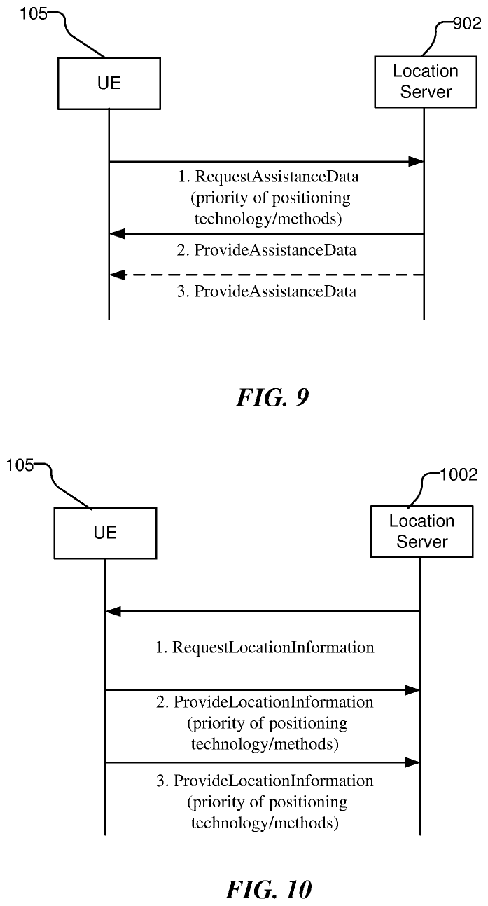

FIG. 9, for example, illustrates an LPP Assistance Data Transfer procedure, in which the UE 105 may provide the priority list of the one or more positioning technologies, positioning methods or combination thereof to a location server 902, which may be, e.g., the LMF 120 or an E-SMLC, SLP, or other server. The Assistance Data Transfer procedure enables the UE 105 to request assistance data from the server 902 to assist in positioning, and to enable the server 902 to transfer assistance data to the 105 in the absence of a request. Additionally, the request for assistance data may provide a mechanism with which the UE 105 may provide a recommendation or request for one or more positioning technologies and/or positioning methods.

At stage 1 of FIG. 9, the UE 105 sends a RequestAssistanceData message to the server 902. The ProvideCapabilities message may further include priority list of the one or more positioning technologies, positioning methods or combination thereof, e.g., in one or more IEs that correspond to different positioning technologies and methods in the body of the message or in a common IE.

At stage 2 of FIG. 9, the server 902 responds with a ProvideAssistanceData message to the target containing assistance data. The transferred assistance data should match or be a subset of the assistance data requested in stage 1, and may be based on priority list of the one or more positioning technologies, positioning methods or combination thereof. The server 902 may also provide any not requested information that it considers useful to the target. If stage 3 does not occur, the message at stage 2 shall set the endTransaction IE to TRUE.

At stage 3 of FIG. 9, the server 902 may transmit one or more additional ProvideAssistanceData messages to the target containing further assistance data. The transferred assistance data should match or be a subset of the assistance data requested in stage 1. The server may also provide any not requested information that it considers useful to the UE 105. The last message shall include the endTransaction IE set to TRUE.

Table 2, below, for example, illustrates a RequestAssistanceData message, e.g., based on a fragment of Abstract Syntax Notation One (ASN.1), which shows the message body indicates the LPP capabilities of the UE 105 and includes a common IE, i.e., commonIEProvideCapabilities.

TABLE 2
RequestAssistanceData-r9-IEs ::= SEQUENCE {

| | |
|---|---|
| commonIEsRequestAssistanceData | |
| CommonIEsRequestAssistanceData | OPTIONAL, ..., |
| a-gnss-RequestAssistanceData | A-GNSS-RequestAssistanceData |
| OPTIONAL, ..., | |
| otdoa-RequestAssistanceData | OTDOA-RequestAssistanceData |
| OPTIONAL, ..., | |
| epdu-RequestAssistanceData | EPDU-Sequence |
| OPTIONAL, ..., | |
| [[ sensor-RequestAssistanceData-r14 | |
| | Sensor- |
| RequestAssistanceData-r14 OPTIONAL, ..., | |
| tbs-RequestAssistanceData-r14 | TBS-RequestAssistanceData-r14 |
| OPTIONAL, ..., | |
| wlan-RequestAssistanceData-r14 | WLAN-RequestAssistanceData-r14 |
| OPTIONAL ..., | |
| ]], | |
| [[ nr-Multi-RTT-RequestAssistanceData-r16 | NR-Multi-RTT-RequestAssistanceData-r16 |
| OPTIONAL, ..., | |
| nr-DL-AoD-RequestAssistanceData-r16 | NR-DL-AoD-RequestAssistanceData-r16 |
| OPTIONAL, ..., | |
| nr-DL-TD0A-RequestAssistanceData-r16 | NR-DL-TDOA-RequestAssistanceData-r16 |
| OPTIONAL ..., | |
| ]] | |
| } | |

The CommonIEsRequestAssistanceData carries common IEs for a Request Assistance Data LPP message Type, e.g., as illustrated in Table 3.

```
TABLE 3
CommonIEsRequestAssistanceData ::= SEQUENCE {
  primaryCellID  ECGI  OPTIONAL, --Cond EUTRA
  ...,
  [[
    segmentationInfo-r14  SegmentationInfo-r14
  OPTIONAL --Cond Segmentation
  ]],
  [[
    periodicAssistanceDataReq-r15
  PeriodicAssistanceDataControlParameters-r15
      OPTIONAL, --Cond PerADreq
    primaryCellID-r15 NCGI-r15
    OPTIONAL --Cond NR
  ]]
}
```

The priority list of the one or more positioning technologies, positioning methods or combination, for example, may be provided in the CommonIEsRequestAssistanceData or the by ranking the individual IEs associated with the positioning technologies and positioning methods in the RequestAssistanceData message.

FIG. 10, for example, illustrates an LPP Location Information Transfer procedure in which the UE 105 may provide the priority list of the one or more positioning technologies, positioning methods or combination thereof to a location server 1002, which may be, e.g., the LMF 120 or an E-SMLC, SLP, or other server. LPP Location Information Transfer enables the UE 105 to report positioning measurements and/or a location estimate to the server 1002. Additionally, the Location Information Transfer procedure may provide a mechanism with which the UE 105 may provide technology report for the reported location estimate and a recommendation or request for one or more positioning technologies and/or positioning methods, e.g., for a future positioning session.

At stage 1 of FIG. 10, the server 1002 sends a RequestLocationInformation message to the UE 105 to request location information, indicating the type of location information needed and potentially the associated QoS, and may further indicate whether a priority list of the one or more positioning technologies, positioning methods or combination thereof is to be provided by the UE 105, if capable.

At stage 2, the UE 105 sends a ProvideLocationInformation message to the server to transfer location information. The location information transferred should match or be a subset of the location information requested in stage 1 unless the server explicitly allows additional location information. The location information may include the priority list of the one or more positioning technologies, positioning methods or combination thereof. If stage 3 does not occur, this message may set the endTransaction IE to TRUE.

At stage 3, if requested in stage 1, the UE 105 may send additional ProvideLocationInformation messages to the server to transfer location information. The location information transferred should match or be a subset of the location information requested in stage 1 unless the server explicitly allows additional location information. The location information may include the priority list of the one or more positioning technologies, positioning methods or combination thereof. The last message shall include the endTransaction IE set to TRUE.

The ProvideLocationInformation message may include CommonIEsProvideLocationInformation, that carries common IEs for a Provide Location Information LPP message Type. Table 4, below, for example, illustrates a CommonIEsProvideLocationInformation, e.g., based on a fragment of Abstract Syntax Notation One (ASN.1).

TABLE 4

| CommonIEsProvideLocationInformation ::= SEQUENCE { | |
|---|---|
| locationEstimate | LocationCoordinates |
| OPTIONAL, | |
| velocityEstimate | Velocity |
| OPTIONAL, | |
| locationError | LocationError |
| OPTIONAL, | |
| ..., | |
| [[ earlyFixReport-r12 | EarlyFixReport-r12 |
| OPTIONAL | |
| ]], | |
| [[ locationSource-r13 | LocationSource-r13 |
| OPTIONAL, | |
| locationTimestamp-r13 | UTCTime |
| OPTIONAL | |
| ]], | |
| [[ | |
| segmentationInfo-r14 SegmentationInfo-r14 OPTIONAL | |
| --Cond Segmentation | |
| ]] | |
| } | |

The locationSource field in the CommonIEsProvideLocationInformation provides the source positioning technology for the location estimate, and is shown in TABLE 5.

TABLE 5

| | |
|---|---|
| LocationSource-r13 ::= BIT STRING { a-gnss | (0), |
| wlan | (1), |
| bt | (2), |
| tbs | (3), |
| sensor | (4), |
| ha-gnss-v1510 | (5), |

motion-sensor-v1550 (6) } (SIZE(1..16))

In this version of the specification, the entry ‘tbs’ may be used only for TBS positioning based on MBS signals, and the entry ‘sensor’ is used only for positioning technology that uses barometric pressure sensor. The entry ‘motion-sensor’ may be used for positioning technology that uses sensor(s) to detect displacement and movement, e.g. accelerometers, gyros, magnetometers.

The priority list of the one or more positioning technologies, positioning methods or combination, for example, may be provided in the LocationSource.

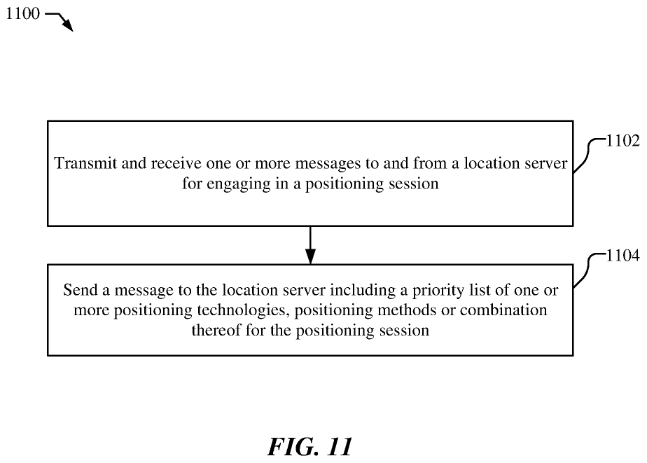

FIG. 11 shows a flowchart for an exemplary method 1100 for supporting position determination of a UE, such as UE 105, performed by the UE in a wireless network.

At block 1102, the UE transmits and receives one or more messages to and from a location server for engaging in a positioning session. For example, the UE may transmit and receive one or more messages including a Request Capabilities; Provide Capabilities; Request Assistance Data; Request Priority, Assistance Data; Request Location Information; and Provide Location Information, e.g., as discussed at stages 2, 3, 7, 9, 11, 12, and 15 of FIG. 6, and discussed in FIGS. 7-10. A means for transmitting and receiving one or more messages to and from a location server for engaging in a positioning session may include, e.g., the interface 214 and transceiver 215, and one or more processors 210 with dedicated hardware or implementing executable code or software instructions in memory 211, such as the LPP message exchange module 272, in UE 200 shown in FIG. 2.

At block 1104, the UE sends a message to the location server including a priority list of one or more positioning technologies, positioning methods or combination thereof for the positioning session. For example, the UE may send a priority list of one or more positioning technologies, positioning methods or combination thereof in any one or more of the Provide Capabilities message, Request Assistance Data message, Provide Priority message, and the Provide Location Information message, e.g., as discussed at stages 3, 8, 9, and 15 of FIG. 6, and discussed in FIGS. 7-10. For example, the message may be a provide capabilities message in which the UE provides capabilities of the UE to the location server to perform the one or more positioning technologies, positioning methods or combination thereof and includes a priority for the one or more positioning technologies, positioning methods or combination thereof. In another example, the message may be an assistance data request message in which the UE requests assistance data from the location server for the one or more positioning technologies, positioning methods or combination thereof and includes a priority for the one or more positioning technologies, positioning methods or combination thereof. In another example, the message may be a stand-alone provide positioning priority message. The UE may receive a request for positioning priority message and may send the provide positioning priority message in response to the request, and in another example, the provide positioning priority message may be unsolicited. A means for receiving a request for positioning priority message, wherein the provide positioning priority message is sent in response to the request for positioning priority message may include, e.g., the interface 214 and transceiver 215, and one or more processors 210 with dedicated hardware or implementing executable code or software instructions in memory 211, such as the LPP message exchange module 272, in UE 200 shown in FIG. 2. The provide positioning priority message may be sent periodically to the location server. In another example, the message may be a provide location information message in which the UE provides to the location server a report based on positioning measurements for the positioning session and includes the priority of the one or more positioning technologies, positioning methods or combination thereof in generating the report. The priority list may indicate a priority in one or more information elements (IEs) associated with the one or more positioning technologies, positioning methods or combination thereof or may indicate a priority of the one or more positioning technologies, positioning methods or combination thereof inside a common IE. A means for sending a message to the location server including a priority list of one or more positioning technologies, positioning methods or combination thereof for the positioning session may include, e.g., the interface 214 and transceiver 215, and one or more processors 210 with dedicated hardware or implementing executable code or software instructions in memory 211, such as the priority list module 274, in UE 200 shown in FIG. 2.

In one implementation, the priority list of the one or more positioning technologies, positioning methods or a combination thereof may be a request to the location server to use the one or more positioning technologies, positioning methods or a combination thereof in a future positioning session, e.g., as discussed in FIG. 6. In one implementation, the priority list of the one or more positioning technologies, positioning methods or a combination thereof comprises a request to the location server to use the one or more positioning technologies, positioning methods or a combination thereof in the positioning session, e.g., as discussed in FIG. 6.

In one implementation, the positioning technologies may include one or more of LTE, 5G NR, sidelink positioning, SPS, sensors, TBS, WLAN, and Blue-Tooth, and the positioning methods may include one or more of DL TDOA, DL AoD, UL TDOA, UL AoA, RTT, multi-RTT using one or more base stations, one or more UEs, or a combination thereof, E-CID, UE based SPS, UE assisted SPS, inertial sensors, and barometric sensors.

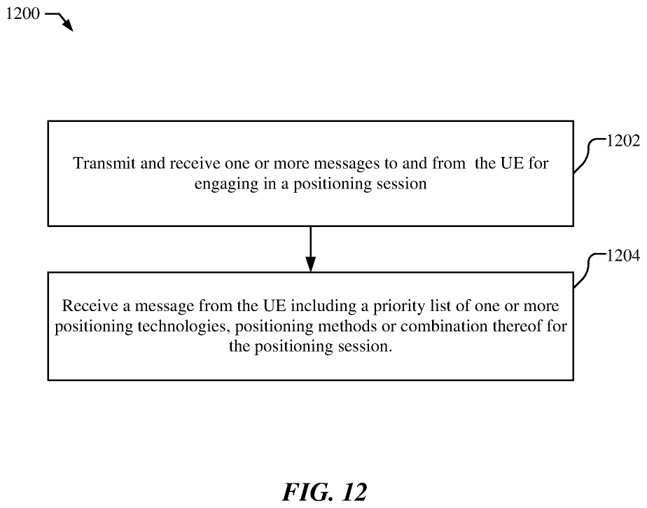

FIG. 12 shows a flowchart for an exemplary method 1200 for supporting position determination of a UE, such as UE 105, performed by a location server, such as LMF 120, an E-SMLC, or SLP, in a wireless network.

At block 1202, the location server transmits and receives one or more messages to and from the UE for engaging in a positioning session. For example, the location server may transmit and receive one or more messages including a Request Capabilities; Provide Capabilities; Request Assistance Data; Request Priority, Assistance Data; Request Location Information; and Provide Location Information, e.g., as discussed at stages 2, 3, 7, 9, 11, 12, and 15 of FIG. 6, and discussed in FIGS. 7-10. The processor 410, the transceiver 415, and the memory 411 may comprise means for transmit and receive one or more messages to and from the UE for engaging in a positioning session may include, e.g., the transceiver 415, and one or more processors 410 with dedicated hardware or implementing executable code or software instructions in memory 411, such as the LPP message exchange module 472, in location server 400 shown in FIG. 4.

At block 1204, the location server receives a message from the UE including a priority list of one or more positioning technologies, positioning methods or combination thereof for the positioning session. For example, the location server may receive a priority list of one or more positioning technologies, positioning methods or combination thereof in any one or more of the Provide Capabilities message, Request Assistance Data message, Provide Priority message, and the Provide Location Information message, e.g., as discussed at stages 3, 8, 9, and 15 of FIG. 6, and discussed in FIGS. 7-10. For example, the message may be a provide capabilities message in which the location server receives capabilities of the UE to perform the one or more positioning technologies, positioning methods or combination thereof and includes a priority for the one or more positioning technologies, positioning methods or combination thereof. In another example, the message may be an assistance data request message in which the location server receives a request assistance data for the one or more positioning technologies, positioning methods or combination thereof and includes a priority for the one or more positioning technologies, positioning methods or combination thereof. In another example, the message may be a stand-alone provide positioning priority message. The location server may send a request for positioning priority message and may receive the provide positioning priority message in response to the request, and in another example, the provide positioning priority message may be unsolicited. A means for sending a request for positioning priority message, wherein the provide positioning priority message is received in response to the request for positioning priority message may include, e.g., the transceiver 415, and one or more processors 410 with dedicated hardware or implementing executable code or software instructions in memory 411, such as the LPP message exchange module 472, in location server 400 shown in FIG. 4. The provide positioning priority message may be received periodically from the UE. In another example, the message may be a provide location information message in which the location server receives from the UE a report based on positioning measurements for the positioning session and includes the priority of the one or more positioning technologies, positioning methods or combination thereof in generating the report. The priority list may indicate a priority in one or more information elements (IEs) associated with the one or more positioning technologies, positioning methods or combination thereof or may indicate a priority of the one or more positioning technologies, positioning methods or combination thereof inside a common IE. A means for receiving a message from the UE including a priority list of one or more positioning technologies, positioning methods or combination thereof for the positioning session may include, e.g., the transceiver 415, and one or more processors 410 with dedicated hardware or implementing executable code or software instructions in memory 411, such as the priority list module 474, in location server 400 shown in FIG. 4.

In one implementation, the priority list of the one or more positioning technologies, positioning methods or a combination thereof may be a request to the location server to use the one or more positioning technologies, positioning methods or a combination thereof in a future positioning session, and the location server may configure positioning methods for a subsequent positioning session based on the priority list, e.g., as discussed in stages 17 and 10 of FIG. 6. A means for configuring positioning methods for a subsequent positioning session based on the priority list may include, e.g., the transceiver 415, and one or more processors 410 with dedicated hardware or implementing executable code or software instructions in memory 411, such as the LPP message exchange module 472, in location server 400 shown in FIG. 4. The location server may send assistance data to the UE for the positioning methods, e.g., as discussed at stage 11 of FIG. 6. A means for sending assistance data to the UE for the positioning methods may include, e.g., the transceiver 415, and one or more processors 410 with dedicated hardware or implementing executable code or software instructions in memory 411, such as the LPP message exchange module 472, in location server 400 shown in FIG. 4.

In one implementation, the priority list of the one or more positioning technologies, positioning methods or a combination thereof may be a request to the location server to use the one or more positioning technologies, positioning methods or a combination thereof in the positioning session, and the location server may configure positioning methods for the positioning session based on the priority list, e.g., as discussed in stages 10 of FIG. 6. A means for configuring positioning methods for the positioning session based on the priority list may include, e.g., the transceiver 415, and one or more processors 410 with dedicated hardware or implementing executable code or software instructions in memory 411, such as the LPP message exchange module 472, in location server 400 shown in FIG. 4. The location server may send assistance data to the UE for the positioning methods, e.g., as discussed at stage 11 of FIG. 6. A means for sending assistance data to the UE for the positioning methods may include, e.g., the transceiver 415, and one or more processors 410 with dedicated hardware or implementing executable code or software instructions in memory 411, such as the LPP message exchange module 472, in location server 400 shown in FIG. 4.

In one implementation, the positioning technologies may include one or more of LTE, 5G NR, sidelink positioning SPS, sensors, TBS, WLAN, and Blue-Tooth, and the positioning methods may include one or more of DL TDOA, DL AoD, UL TDOA, UL AoA, RTT, multi-RTT with one or more base stations, one or more other UEs, or a combination thereof, E-CID, UE based SPS, UE assisted SPS, inertial sensors, and barometric sensors.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

In view of this description embodiments may include different combinations of features. Implementation examples are described in the following numbered clauses:

Clause 1. A method performed by a user equipment (UE) in a wireless network for supporting position determination of the UE, comprising: transmitting and receiving one or more messages to and from a location server for engaging in a positioning session; and sending a message to the location server including a priority list of one or more positioning technologies, positioning methods or combination thereof for the positioning session.

Clause 2. The method of clause 1, wherein the priority list indicates a priority in one or more information elements (IEs) associated with the one or more positioning technologies, positioning methods or combination thereof.

Clause 3. The method of either of clauses 1 or 2, wherein the priority list indicates a priority of the one or more positioning technologies, positioning methods or combination thereof inside a common information element (IE).

Clause 4. The method of any of clauses 1-3, wherein the message including the priority list of the one or more positioning technologies, positioning methods or a combination thereof comprises a provide capabilities message in which the UE provides capabilities of the UE to the location server to perform the one or more positioning technologies, positioning methods or combination thereof and includes a priority for the one or more positioning technologies, positioning methods or combination thereof.

Clause 5. The method of any of clauses 1-4, wherein the message including the priority list of the one or more positioning technologies, positioning methods or a combination thereof comprises an assistance data request message in which the UE requests assistance data from the location server for the one or more positioning technologies, positioning methods or combination thereof and includes a priority for the one or more positioning technologies, positioning methods or combination thereof.

Clause 6. The method of any of clauses 1-5, wherein the message including the priority list of the one or more positioning technologies, positioning methods or a combination thereof comprises a provide positioning priority message.

Clause 7. The method of clause 6, further comprising receiving a request for positioning priority message, wherein the provide positioning priority message is sent in response to the request for positioning priority message.

Clause 8. The method of either of clauses 6 or 7, wherein the provide positioning priority message is unsolicited.

Clause 9. The method of any of clauses 6-8, wherein the provide positioning priority message is sent periodically to the location server.

Clause 10. The method of any of clauses 1-9, wherein the message including the priority list of the one or more positioning technologies, positioning methods or a combination thereof comprises a provide location information message in which the UE provides to the location server a report based on positioning measurements for the positioning session and includes the priority of the one or more positioning technologies, positioning methods or combination thereof in generating the report.

Clause 11. The method of clause 10, wherein the priority list of the one or more positioning technologies, positioning methods or a combination thereof comprises a request to the location server to use the one or more positioning technologies, positioning methods or a combination thereof in a future positioning session.

Clause 12. The method of any of clauses 1-11, wherein the priority list of the one or more positioning technologies, positioning methods or a combination thereof comprises a request to the location server to use the one or more positioning technologies, positioning methods or a combination thereof in the positioning session.

Clause 13. The method of any of clauses 1-12, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

Clause 14. A user equipment (UE) configured to support position determination of the UE in a wireless network, comprising: a wireless transceiver; at least one memory; at least one processor coupled to the wireless transceiver and the at least one memory, wherein the at least one processor is configured to: transmit and receive, via the wireless transceiver, one or more messages to and from a location server for engaging in a positioning session; and send, via the wireless transceiver, a message to the location server including a priority list of one or more positioning technologies, positioning methods or combination thereof for the positioning session.

Clause 15. The UE of clause 14, wherein the priority list indicates a priority in one or more information elements (IEs) associated with the one or more positioning technologies, positioning methods or combination thereof.

Clause 16. The UE of either of clauses 14 or 15, wherein the priority list indicates a priority of the one or more positioning technologies, positioning methods or combination thereof inside a common information element (IE).

Clause 17. The UE of any of clauses 14-16, wherein the message including the priority list of the one or more positioning technologies, positioning methods or a combination thereof comprises a provide capabilities message in which the UE provides capabilities of the UE to the location server to perform the one or more positioning technologies, positioning methods or combination thereof and includes a priority for the one or more positioning technologies, positioning methods or combination thereof.

Clause 18. The UE of any of clauses 14-17, wherein the message including the priority list of the one or more positioning technologies, positioning methods or a combination thereof comprises an assistance data request message in which the UE requests assistance data from the location server for the one or more positioning technologies, positioning methods or combination thereof and includes a priority for the one or more positioning technologies, positioning methods or combination thereof.

Clause 19. The UE of any of clauses 14-18, wherein the message including the priority list of the one or more positioning technologies, positioning methods or a combination thereof comprises a provide positioning priority message.

Clause 20. The UE of clause 19, wherein the at least one processor is further configured to receive, via the wireless transceiver, a request for positioning priority message, wherein the provide positioning priority message is sent in response to the request for positioning priority message.

Clause 21. The UE of either of clauses 19 or 20, wherein the provide positioning priority message is unsolicited.

Clause 22. The UE of any of clauses 19-21, wherein the provide positioning priority message is sent periodically to the location server.

Clause 23. The UE of any of clauses 14-22, wherein the message including the priority list of the one or more positioning technologies, positioning methods or a combination thereof comprises a provide location information message in which the UE provides to the location server a report based on positioning measurements for the positioning session and includes the priority of the one or more positioning technologies, positioning methods or combination thereof in generating the report.

Clause 24. The UE of clause 23, wherein the priority list of the one or more positioning technologies, positioning methods or a combination thereof comprises a request to the location server to use the one or more positioning technologies, positioning methods or a combination thereof in a future positioning session.

Clause 25. The UE of any of clauses 14-24, wherein the priority list of the one or more positioning technologies, positioning methods or a combination thereof comprises a request to the location server to use the one or more positioning technologies, positioning methods or a combination thereof in the positioning session.

Clause 26. The UE of any of clauses 14-25, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

Clause 27. A user equipment (UE) in a wireless network configured to support position determination of the UE, comprising: means for transmitting and receiving one or more messages to and from a location server for engaging in a positioning session; and means for sending a message to the location server including a priority list of one or more positioning technologies, positioning methods or combination thereof for the positioning session.

Clause 28. The UE of clause 27, wherein the priority list indicates a priority in one or more information elements (IEs) associated with the one or more positioning technologies, positioning methods or combination thereof.

Clause 29. The UE of either of clauses 27 or 28, wherein the priority list indicates a priority of the one or more positioning technologies, positioning methods or combination thereof inside a common information element (IE).

Clause 30. The UE of any of clauses 27-29, wherein the message including the priority list of the one or more positioning technologies, positioning methods or a combination thereof comprises a provide capabilities message in which the UE provides capabilities of the UE to the location server to perform the one or more positioning technologies, positioning methods or combination thereof and includes a priority for the one or more positioning technologies, positioning methods or combination thereof.

Clause 31. The UE of any of clauses 27-30, wherein the message including the priority list of the one or more positioning technologies, positioning methods or a combination thereof comprises an assistance data request message in which the UE requests assistance data from the location server for the one or more positioning technologies, positioning methods or combination thereof and includes a priority for the one or more positioning technologies, positioning methods or combination thereof.

Clause 32. The UE of any of clauses 27-31, wherein the message including the priority list of the one or more positioning technologies, positioning methods or a combination thereof comprises a provide positioning priority message.

Clause 33. The UE of clause 32, further comprising means for receiving a request for positioning priority message, wherein the provide positioning priority message is sent in response to the request for positioning priority message.

Clause 34. The UE of either of clauses 32 or 33, wherein the provide positioning priority message is unsolicited.

Clause 35. The UE of any of clauses 32-34, wherein the provide positioning priority message is sent periodically to the location server.

Clause 36. The UE of any of clauses 27-35, wherein the message including the priority list of the one or more positioning technologies, positioning methods or a combination thereof comprises a provide location information message in which the UE provides to the location server a report based on positioning measurements for the positioning session and includes the priority of the one or more positioning technologies, positioning methods or combination thereof in generating the report.

Clause 37. The UE of clause 36, wherein the priority list of the one or more positioning technologies, positioning methods or a combination thereof comprises a request to the location server to use the one or more positioning technologies, positioning methods or a combination thereof in a future positioning session.

Clause 38. The UE of any of clauses 27-37, wherein the priority list of the one or more positioning technologies, positioning methods or a combination thereof comprises a request to the location server to use the one or more positioning technologies, positioning methods or a combination thereof in the positioning session.

Clause 39. The UE of any of clauses 27-38, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

Clause 40. A non-transitory storage medium including program code stored thereon, the program code is operable to configure at least one processor in a user equipment (UE) in a wireless network to support position determination of the UE, the program code comprising instruction to: transmit and receive one or more messages to and from a location server for engaging in a positioning session; and send a message to the location server including a priority list of one or more positioning technologies, positioning methods or combination thereof for the positioning session.

Clause 41. The non-transitory storage medium of clause 40, wherein the priority list indicates a priority in one or more information elements (IEs) associated with the one or more positioning technologies, positioning methods or combination thereof.

Clause 42. The non-transitory storage medium of either of clauses 40 or 41, wherein the priority list indicates a priority of the one or more positioning technologies, positioning methods or combination thereof inside a common information element (IE).

Clause 43. The non-transitory storage medium of any of clauses 40-41, wherein the message including the priority list of the one or more positioning technologies, positioning methods or a combination thereof comprises a provide capabilities message in which the UE provides capabilities of the UE to the location server to perform the one or more positioning technologies, positioning methods or combination thereof and includes a priority for the one or more positioning technologies, positioning methods or combination thereof.

Clause 44. The non-transitory storage medium of any of clauses 40-43, wherein the message including the priority list of the one or more positioning technologies, positioning methods or a combination thereof comprises an assistance data request message in which the UE requests assistance data from the location server for the one or more positioning technologies, positioning methods or combination thereof and includes a priority for the one or more positioning technologies, positioning methods or combination thereof.

Clause 45. The non-transitory storage medium of any of clauses 40-44, wherein the message including the priority list of the one or more positioning technologies, positioning methods or a combination thereof comprises a provide positioning priority message.

Clause 46. The non-transitory storage medium of clause 45, wherein the program code further comprises instructions to receive a request for positioning priority message, wherein the provide positioning priority message is sent in response to the request for positioning priority message.

Clause 47. The non-transitory storage medium of either of clauses 45 or 46, wherein the provide positioning priority message is unsolicited.

Clause 48. The non-transitory storage medium of any of clauses 45-47, wherein the provide positioning priority message is sent periodically to the location server.

Clause 49. The non-transitory storage medium of any of clauses 40-48, wherein the message including the priority list of the one or more positioning technologies, positioning methods or a combination thereof comprises a provide location information message in which the UE provides to the location server a report based on positioning measurements for the positioning session and includes the priority of the one or more positioning technologies, positioning methods or combination thereof in generating the report.

Clause 50. The non-transitory storage medium of clause 49, wherein the priority list of the one or more positioning technologies, positioning methods or a combination thereof comprises a request to the location server to use the one or more positioning technologies, positioning methods or a combination thereof in a future positioning session.

Clause 51. The non-transitory storage medium of any of clauses 40-50, wherein the priority list of the one or more positioning technologies, positioning methods or a combination thereof comprises a request to the location server to use the one or more positioning technologies, positioning methods or a combination thereof in the positioning session.

Clause 52. The non-transitory storage medium of any of clauses 40-51, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

Clause 53. A method performed by a location server in a wireless network for supporting position determination of a user equipment (UE), comprising: transmitting and receiving one or more messages to and from the UE for engaging in a positioning session; and receiving a message from the UE including a priority list of one or more positioning technologies, positioning methods or combination thereof for the positioning session.

Clause 54. The method of clause 53, wherein the priority list indicates a priority in one or more information elements (IEs) associated with the one or more positioning technologies, positioning methods or combination thereof.

Clause 55. The method of either of clauses 53 or 54, wherein the priority list indicates a priority of the one or more positioning technologies, positioning methods or combination thereof inside a common information element (IE).

Clause 56. The method of any of clauses 53-55, wherein the message including the priority list of the one or more positioning technologies, positioning methods or a combination thereof comprises a provide capabilities message in which the UE provides capabilities of the UE to perform the one or more positioning technologies, positioning methods or combination thereof and includes a priority for the one or more positioning technologies, positioning methods or combination thereof.

Clause 57. The method of any of clauses 53-56, wherein the message including the priority list of the one or more positioning technologies, positioning methods or a combination thereof comprises an assistance data request message in which the UE requests assistance data for the one or more positioning technologies, positioning methods or combination thereof and includes a priority for the one or more positioning technologies, positioning methods or combination thereof.

Clause 58. The method of any of clauses 53-57, wherein the message including the priority list of the one or more positioning technologies, positioning methods or a combination thereof comprises a provide positioning priority message.

Clause 59. The method of clause 58, further comprising sending a request for positioning priority message, wherein the provide positioning priority message is received in response to the request for positioning priority message.

Clause 60. The method of either of clauses 58 or 59, wherein the provide positioning priority message is unsolicited.

Clause 61. The method of any of clauses 58-60, wherein the provide positioning priority message is received periodically from the UE.

Clause 62. The method of any of clauses 53-61, wherein the message including the priority list of the one or more positioning technologies, positioning methods or a combination thereof comprises a provide location information message in which the UE provides a report based on positioning measurements for the positioning session and includes the priority of the one or more positioning technologies, positioning methods or combination thereof in generating the report.

Clause 63. The method of clause 62, wherein the priority list of the one or more positioning technologies, positioning methods or a combination thereof comprises a request to the location server to use the one or more positioning technologies, positioning methods or a combination thereof in a future positioning session, the method further comprising: configuring positioning methods for a subsequent positioning session based on the priority list; and sending assistance data to the UE for the positioning methods.

Clause 64. The method of any of clauses 53-63, wherein the priority list of the one or more positioning technologies, positioning methods or a combination thereof comprises a request to the location server to use the one or more positioning technologies, positioning methods or a combination thereof in the positioning session, the method further comprising: configuring positioning methods for the positioning session based on the priority list; and sending assistance data to the UE for the positioning methods.

Clause 65. The method of any of clauses 53-64, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

Clause 66. A location server configured to support position determination of a user equipment (UE) performed in a wireless network, comprising: an external interface; at least one memory; at least one processor coupled to the external interface and the at least one memory, wherein the at least one processor is configured to: transmit and receive, via the external interface, one or more messages to and from the UE for engaging in a positioning session; and receive a, via the external interface, message from the UE including a priority list of one or more positioning technologies, positioning methods or combination thereof for the positioning session.

Clause 67. The location server of clause 66, wherein the priority list indicates a priority in one or more information elements (IEs) associated with the one or more positioning technologies, positioning methods or combination thereof.

Clause 68. The location server of either of clauses 66 or 67, wherein the priority list indicates a priority of the one or more positioning technologies, positioning methods or combination thereof inside a common information element (IE).

Clause 69. The location server of any of clauses 66-68, wherein the message including the priority list of the one or more positioning technologies, positioning methods or a combination thereof comprises a provide capabilities message in which the UE provides capabilities of the UE to perform the one or more positioning technologies, positioning methods or combination thereof and includes a priority for the one or more positioning technologies, positioning methods or combination thereof.

Clause 70. The location server of any of clauses 66-69, wherein the message including the priority list of the one or more positioning technologies, positioning methods or a combination thereof comprises an assistance data request message in which the UE requests assistance data for the one or more positioning technologies, positioning methods or combination thereof and includes a priority for the one or more positioning technologies, positioning methods or combination thereof.

Clause 71. The location server of any of clauses 66-70, wherein the message including the priority list of the one or more positioning technologies, positioning methods or a combination thereof comprises a provide positioning priority message.

Clause 72. The location server of clause 71, wherein the at least one processor is further configured to send, via the external interface, a request for positioning priority message, wherein the provide positioning priority message is received in response to the request for positioning priority message.

Clause 73. The location server of either of clauses 71 or 72, wherein the provide positioning priority message is unsolicited.

Clause 74. The location server of any of clauses 71-73, wherein the provide positioning priority message is received periodically from the UE.

Clause 75. The location server of any of clauses 66-74, wherein the message including the priority list of the one or more positioning technologies, positioning methods or a combination thereof comprises a provide location information message in which the UE provides a report based on positioning measurements for the positioning session and includes the priority of the one or more positioning technologies, positioning methods or combination thereof in generating the report.

Clause 76. The location server of clause 75, wherein the priority list of the one or more positioning technologies, positioning methods or a combination thereof comprises a request to the location server to use the one or more positioning technologies, positioning methods or a combination thereof in a future positioning session, wherein the at least one processor is further configured to: configure positioning methods for a subsequent positioning session based on the priority list; and send, via the external interface, assistance data to the UE for the positioning methods.

Clause 77. The location server of any of clauses 66-76, wherein the priority list of the one or more positioning technologies, positioning methods or a combination thereof comprises a request to the location server to use the one or more positioning technologies, positioning methods or a combination thereof in the positioning session, wherein the at least one processor is further configured to: configure positioning methods for the positioning session based on the priority list; and send, via the external interface, assistance data to the UE for the positioning methods.

Clause 78. The location server of any of clauses 66-77, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

Clause 79. A location server configured to support position determination of a user equipment (UE), comprising: means for transmitting and receiving one or more messages to and from the UE for engaging in a positioning session; and means for receiving a message from the UE including a priority list of one or more positioning technologies, positioning methods or combination thereof for the positioning session.

Clause 80. The location server of clause 79, wherein the priority list indicates a priority in one or more information elements (IEs) associated with the one or more positioning technologies, positioning methods or combination thereof.

Clause 81. The location server of either of clauses 79 or 80, wherein the priority list indicates a priority of the one or more positioning technologies, positioning methods or combination thereof inside a common information element (IE).

Clause 82. The location server of any of clauses 79-81, wherein the message including the priority list of the one or more positioning technologies, positioning methods or a combination thereof comprises a provide capabilities message in which the UE provides capabilities of the UE to perform the one or more positioning technologies, positioning methods or combination thereof and includes a priority for the one or more positioning technologies, positioning methods or combination thereof.

Clause 83. The location server of any of clauses 79-82, wherein the message including the priority list of the one or more positioning technologies, positioning methods or a combination thereof comprises an assistance data request message in which the UE requests assistance data for the one or more positioning technologies, positioning methods or combination thereof and includes a priority for the one or more positioning technologies, positioning methods or combination thereof.

Clause 84. The location server of any of clauses 79-83, wherein the message including the priority list of the one or more positioning technologies, positioning methods or a combination thereof comprises a provide positioning priority message.

Clause 85. The location server of clause 84, further comprising means for sending a request for positioning priority message, wherein the provide positioning priority message is received in response to the request for positioning priority message.

Clause 86. The location server of either of clauses 84 or 85, wherein the provide positioning priority message is unsolicited.

Clause 87. The location server of any of clauses 84-86, wherein the provide positioning priority message is received periodically from the UE.

Clause 88. The location server of any of clauses 79-87, wherein the message including the priority list of the one or more positioning technologies, positioning methods or a combination thereof comprises a provide location information message in which the UE provides a report based on positioning measurements for the positioning session and includes the priority of the one or more positioning technologies, positioning methods or combination thereof in generating the report.

Clause 89. The location server of clause 88, wherein the priority list of the one or more positioning technologies, positioning methods or a combination thereof comprises a request to the location server to use the one or more positioning technologies, positioning methods or a combination thereof in a future positioning session, further comprising: means for configuring positioning methods for a subsequent positioning session based on the priority list; and means for sending assistance data to the UE for the positioning methods.

Clause 90. The location server of any of clauses 79-89, wherein the priority list of the one or more positioning technologies, positioning methods or a combination thereof comprises a request to the location server to use the one or more positioning technologies, positioning methods or a combination thereof in the positioning session, further comprising: means for configuring positioning methods for the positioning session based on the priority list; and means for sending assistance data to the UE for the positioning methods.

Clause 91. The location server of any of clauses 79-90, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

Clause 92. A non-transitory storage medium including program code stored thereon, the program code is operable to configure at least one processor in a location server to support position determination of a user equipment (UE), the program code comprising instructions to: transmit and receive one or more messages to and from the UE for engaging in a positioning session; and receive a message from the UE including a priority list of one or more positioning technologies, positioning methods or combination thereof for the positioning session.

Clause 93. The non-transitory storage medium of clause 92, wherein the priority list indicates a priority in one or more information elements (IEs) associated with the one or more positioning technologies, positioning methods or combination thereof.

Clause 94. The non-transitory storage medium of either of clauses 92 or 93, wherein the priority list indicates a priority of the one or more positioning technologies, positioning methods or combination thereof inside a common information element (IE).

Clause 95. The non-transitory storage medium of any of clauses 92-94, wherein the message including the priority list of the one or more positioning technologies, positioning methods or a combination thereof comprises a provide capabilities message in which the UE provides capabilities of the UE to perform the one or more positioning technologies, positioning methods or combination thereof and includes a priority for the one or more positioning technologies, positioning methods or combination thereof.

Clause 96. The non-transitory storage medium of any of clauses 92-95, wherein the message including the priority list of the one or more positioning technologies, positioning methods or a combination thereof comprises an assistance data request message in which the UE requests assistance data for the one or more positioning technologies, positioning methods or combination thereof and includes a priority for the one or more positioning technologies, positioning methods or combination thereof.

Clause 97. The non-transitory storage medium of any of clauses 92-96, wherein the message including the priority list of the one or more positioning technologies, positioning methods or a combination thereof comprises a provide positioning priority message.

Clause 98. The non-transitory storage medium of clause 97, wherein the program code further comprising instructions to send a request for positioning priority message, wherein the provide positioning priority message is received in response to the request for positioning priority message.

Clause 99. The non-transitory storage medium of either of clauses 97 or 98, wherein the provide positioning priority message is unsolicited.

Clause 100. The non-transitory storage medium of any of clauses 97-99, wherein the provide positioning priority message is received periodically from the UE.

Clause 101. The non-transitory storage medium of any of clauses 92-100, wherein the message including the priority list of the one or more positioning technologies, positioning methods or a combination thereof comprises a provide location information message in which the UE provides a report based on positioning measurements for the positioning session and includes the priority of the one or more positioning technologies, positioning methods or combination thereof in generating the report.

Clause 102. The non-transitory storage medium of clause 101, wherein the priority list of the one or more positioning technologies, positioning methods or a combination thereof comprises a request to the location server to use the one or more positioning technologies, positioning methods or a combination thereof in a future positioning session, wherein the program code further comprises instructions to: configure positioning methods for a subsequent positioning session based on the priority list; and send assistance data to the UE for the positioning methods.

Clause 103. The non-transitory storage medium of any of clauses 92-102, wherein the priority list of the one or more positioning technologies, positioning methods or a combination thereof comprises a request to the location server to use the one or more positioning technologies, positioning methods or a combination thereof in the positioning session, wherein the program code further comprises instructions to: configure positioning methods for the positioning session based on the priority list; and send assistance data to the UE for the positioning methods.

Clause 104. The non-transitory storage medium of any of clauses 92-103, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

Therefore, it is intended that claimed subject matter not be limited to the particular examples disclosed, but that such claimed subject matter may also include all aspects falling within the scope of appended claims, and equivalents thereof.

What is claimed is:

1. A method performed by a user equipment (UE) in a wireless network for supporting position determination of the UE, comprising:
transmitting and receiving one or more messages to and from a location server for engaging in a positioning session; and
sending a message to the location server including a priority list of one or more positioning technologies, positioning methods or combination thereof for the positioning session.

2. The method of claim 1, wherein the priority list indicates a priority in one or more information elements (IEs) associated with the one or more positioning technologies, positioning methods or combination thereof.

3. The method of claim 1, wherein the priority list indicates a priority of the one or more positioning technologies, positioning methods or combination thereof inside a common information element (IE).

4. The method of claim 1, wherein the message including the priority list of the one or more positioning technologies, positioning methods or a combination thereof comprises a provide capabilities message in which the UE provides capabilities of the UE to the location server to perform the one or more positioning technologies, positioning methods or combination thereof and includes a priority for the one or more positioning technologies, positioning methods or combination thereof.

5. The method of claim 1, wherein the message including the priority list of the one or more positioning technologies, positioning methods or a combination thereof comprises an assistance data request message in which the UE requests assistance data from the location server for the one or more positioning technologies, positioning methods or combination thereof and includes a priority for the one or more positioning technologies, positioning methods or combination thereof.

6. The method of claim 1, wherein the message including the priority list of the one or more positioning technologies, positioning methods or a combination thereof comprises a provide positioning priority message.

7. The method of claim 6, further comprising receiving a request for positioning priority message, wherein the provide positioning priority message is sent in response to the request for positioning priority message.

8. The method of claim 6, wherein the provide positioning priority message is unsolicited.

9. The method of claim 6, wherein the provide positioning priority message is sent periodically to the location server.

10. The method of claim 1, wherein the message including the priority list of the one or more positioning technologies, positioning methods or a combination thereof comprises a provide location information message in which the UE provides to the location server a report based on positioning measurements for the positioning session and includes the priority of the one or more positioning technologies, positioning methods or combination thereof in generating the report.

11. The method of claim 10, wherein the priority list of the one or more positioning technologies, positioning methods or a combination thereof comprises a request to the location server to use the one or more positioning technologies, positioning methods or a combination thereof in a future positioning session.

12. The method of claim 1, wherein the priority list of the one or more positioning technologies, positioning methods or a combination thereof comprises a request to the location server to use the one or more positioning technologies, positioning methods or a combination thereof in the positioning session.

13. The method of claim 1, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more base stations, one or more other UEs, or a combination thereof (multi-RTT), enhanced cell-ID (E-CID), UE based SPS, UE assisted SPS, inertial sensors, and barometric sensors.

14. A user equipment (UE) configured to support position determination of the UE in a wireless network, comprising:
a wireless transceiver;
at least one memory;
at least one processor coupled to the wireless transceiver and the at least one memory, wherein the at least one processor is configured to:
transmit and receive, via the wireless transceiver, one or more messages to and from a location server for engaging in a positioning session; and
send, via the wireless transceiver, a message to the location server including a priority list of one or more positioning technologies, positioning methods or combination thereof for the positioning session.

15. The UE of claim 14, wherein the priority list indicates a priority in one or more information elements (IEs) associated with the one or more positioning technologies, positioning methods or combination thereof.

16. The UE of claim 14, wherein the priority list indicates a priority of the one or more positioning technologies, positioning methods or combination thereof inside a common information element (IE).

17. The UE of claim 14, wherein the message including the priority list of the one or more positioning technologies, positioning methods or a combination thereof comprises a provide capabilities message in which the UE provides capabilities of the UE to the location server to perform the one or more positioning technologies, positioning methods or combination thereof and includes a priority for the one or more positioning technologies, positioning methods or combination thereof.

18. The UE of claim 14, wherein the message including the priority list of the one or more positioning technologies, positioning methods or a combination thereof comprises an assistance data request message in which the UE requests assistance data from the location server for the one or more positioning technologies, positioning methods or combination thereof and includes a priority for the one or more positioning technologies, positioning methods or combination thereof.

19. The UE of claim 14, wherein the message including the priority list of the one or more positioning technologies, positioning methods or a combination thereof comprises a provide positioning priority message.

20. The UE of claim 19, wherein the at least one processor is further configured to receive, via the wireless transceiver, a request for positioning priority message, wherein the provide positioning priority message is sent in response to the request for positioning priority message.

21. The UE of claim 19, wherein the provide positioning priority message is unsolicited.

22. The UE of claim 19, wherein the provide positioning priority message is sent periodically to the location server.

23. The UE of claim 14, wherein the message including the priority list of the one or more positioning technologies, positioning methods or a combination thereof comprises a provide location information message in which the UE provides to the location server a report based on positioning measurements for the positioning session and includes the priority of the one or more positioning technologies, positioning methods or combination thereof in generating the report.

24. The UE of claim 23, wherein the priority list of the one or more positioning technologies, positioning methods or a combination thereof comprises a request to the location server to use the one or more positioning technologies, positioning methods or a combination thereof in a future positioning session.

25. The UE of claim 14, wherein the priority list of the one or more positioning technologies, positioning methods or a combination thereof comprises a request to the location server to use the one or more positioning technologies, positioning methods or a combination thereof in the positioning session.

26. The UE of claim 14, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

27. A method performed by a location server in a wireless network for supporting position determination of a user equipment (UE), comprising:
transmitting and receiving one or more messages to and from the UE for engaging in a positioning session; and
receiving a message from the UE including a priority list of one or more positioning technologies, positioning methods or combination thereof for the positioning session.

28. The method of claim 27, wherein the priority list indicates a priority in one or more information elements (IEs) associated with the one or more positioning technologies, positioning methods or combination thereof.

29. The method of claim 27, wherein the priority list indicates a priority of the one or more positioning technologies, positioning methods or combination thereof inside a common information element (IE).

30. The method of claim 27, wherein the message including the priority list of the one or more positioning technologies, positioning methods or a combination thereof comprises a provide capabilities message in which the UE provides capabilities of the UE to perform the one or more positioning technologies, positioning methods or combination thereof and includes a priority for the one or more positioning technologies, positioning methods or combination thereof.

31. The method of claim 27, wherein the message including the priority list of the one or more positioning technologies, positioning methods or a combination thereof comprises an assistance data request message in which the UE requests assistance data for the one or more positioning technologies, positioning methods or combination thereof and includes a priority for the one or more positioning technologies, positioning methods or combination thereof.

32. The method of claim 27, wherein the message including the priority list of the one or more positioning technologies, positioning methods or a combination thereof comprises a provide positioning priority message.

33. The method of claim 32, further comprising sending a request for positioning priority message, wherein the provide positioning priority message is received in response to the request for positioning priority message.

34. The method of claim 32, wherein the provide positioning priority message is unsolicited.

35. The method of claim 32, wherein the provide positioning priority message is received periodically from the UE.

36. The method of claim 27, wherein the message including the priority list of the one or more positioning technologies, positioning methods or a combination thereof comprises a provide location information message in which the UE provides a report based on positioning measurements for the positioning session and includes the priority of the one or more positioning technologies, positioning methods or combination thereof in generating the report.

37. The method of claim 36, wherein the priority list of the one or more positioning technologies, positioning methods or a combination thereof comprises a request to the location server to use the one or more positioning technologies, positioning methods or a combination thereof in a future positioning session, the method further comprising:
configuring positioning methods for a subsequent positioning session based on the priority list; and
sending assistance data to the UE for the positioning methods.

38. The method of claim 27, wherein the priority list of the one or more positioning technologies, positioning methods or a combination thereof comprises a request to the location server to use the one or more positioning technologies, positioning methods or a combination thereof in the positioning session, the method further comprising:
configuring positioning methods for the positioning session based on the priority list; and
sending assistance data to the UE for the positioning methods.

39. The method of claim 27, wherein positioning technologies comprises one or more of Long Term Evolution (LTE), Fifth Generation New Radio (5G NR), sidelink positioning, satellite positioning system, sensors, terrestrial beacon system (TB S), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.

40. A location server configured to support position determination of a user equipment (UE) performed in a wireless network, comprising:
an external interface;
at least one memory;
at least one processor coupled to the external interface and the at least one memory, wherein the at least one processor is configured to:
transmit and receive, via the external interface, one or more messages to and from the UE for engaging in a positioning session; and
receive, via the external interface, a message from the UE including a priority list of one or more positioning technologies, positioning methods or combination thereof for the positioning session.

41. The location server of claim 40, wherein the priority list indicates a priority in one or more information elements (IEs) associated with the one or more positioning technologies, positioning methods or combination thereof.

42. The location server of claim 40, wherein the priority list indicates a priority of the one or more positioning technologies, positioning methods or combination thereof inside a common information element (IE).

43. The location server of claim 40, wherein the message including the priority list of the one or more positioning technologies, positioning methods or a combination thereof comprises a provide capabilities message in which the UE provides capabilities of the UE to perform the one or more positioning technologies, positioning methods or combination thereof and includes a priority for the one or more positioning technologies, positioning methods or combination thereof.

44. The location server of claim 40, wherein the message including the priority list of the one or more positioning technologies, positioning methods or a combination thereof comprises an assistance data request message in which the UE requests assistance data for the one or more positioning technologies, positioning methods or combination thereof and includes a priority for the one or more positioning technologies, positioning methods or combination thereof.

45. The location server of claim 40, wherein the message including the priority list of the one or more positioning technologies, positioning methods or a combination thereof comprises a provide positioning priority message.

46. The location server of claim 45, wherein the at least one processor is further configured to send, via the external interface, a request for positioning priority message, wherein the provide positioning priority message is received in response to the request for positioning priority message.

47. The location server of claim 45, wherein the provide positioning priority message is unsolicited.

48. The location server of claim 45, wherein the provide positioning priority message is received periodically from the UE.

49. The location server of claim 40, wherein the message including the priority list of the one or more positioning technologies, positioning methods or a combination thereof comprises a provide location information message in which the UE provides a report based on positioning measurements for the positioning session and includes the priority of the one or more positioning technologies, positioning methods or combination thereof in generating the report.

50. The location server of claim 49, wherein the priority list of the one or more positioning technologies, positioning methods or a combination thereof comprises a request to the location server to use the one or more positioning technologies, positioning methods or a combination thereof in a future positioning session, wherein the at least one processor is further configured to:
configure positioning methods for a subsequent positioning session based on the priority list; and
send, via the external interface, assistance data to the UE for the positioning methods.

51. The location server of claim 40, wherein the priority list of the one or more positioning technologies, positioning methods or a combination thereof comprises a request to the location server to use the one or more positioning technologies, positioning methods or a combination thereof in the positioning session, wherein the at least one processor is further configured to:
configure positioning methods for the positioning session based on the priority list; and
send, via the external interface, assistance data to the UE for the positioning methods.

52. The location server of claim 40, wherein positioning technologies comprises one or more of Long Term Evolution (LTE), Fifth Generation New Radio (5G NR), sidelink positioning, satellite positioning system, sensors, terrestrial beacon system (TBS), wireless local area network (WLAN), and Blue-Tooth, and wherein positioning methods comprise one or more of downlink (DL) Time Difference of Arrival (TDOA), DL Angle of Departure (AoD), uplink (UL) TDOA, UL Angle of Arrival (AoA), Round-trip time (RTT) with one or more neighboring base stations, one or more other UEs, or a combination thereof (multi-RTT), enhanced cell-ID (E-CID), UE based SPS, UE assisted SPS, inertial sensors, and barometric sensors.
